(19) United States
(12) Patent Application Publication
(10) Pub. No.: US 2007/0122259 A1
(43) Pub. Date: May 31, 2007

(54) Motorcycle lift and transport system

(76) Inventor: Dennis P. McGrath, Ortonville, MI (US)

Correspondence Address: DENNIS P. McGRATH, 2700 PHEASANT RUN, ORTONVILLE, MI, 48462, US

(21) Appl. No.: 11/605,510

(22) Filed: Nov. 29, 2006

Related U.S. Application Data
(60) Provisional application No. 60/741,647, filed on Nov. 29, 2005.

(51) Int. Cl. B60P 1/00

(52) U.S. Cl. 414/538

(57) ABSTRACT

An engineered Lift System designed such that a single operator may confidently load, transport and unload a two-wheeled Motorcycle or similar device. Said Lift System is constructed of strong and lightweight assemblies not requiring permanent attachment to vehicle. Said Lift System connects primarily to vehicle receiver hitch and secondarily to pockets in vehicle box. Efficient design and simplified assembly methods are employed at each step of construction. Said methods when combined with proven standard components provide a previously unavailable level of control to the difficult task of loading and transporting these valuable yet fragile machines. Massive and high cost components are engineered out while functionality and simplicity are engineered in, providing high value to the user.

### BACKGROUND

This invention relates to lift and transport devices for motor vehicles. Specifically, vehicle mounted lift systems for lifting a heavy “Load” such as a two wheeled Motorcycle, from ground level up to the bed of a vehicle. This Lift System, like some prior art, attaches to vehicle using Receiver Type trailer hitch located below the rear bumper at center of vehicle. Vehicle mounted trailer hitches have been refined and simplified and come as standard equipment on all types of cars and trucks. The broad utility and strength of this receiver hitch/mating hitch system is proven each day as trailers weighing up to 10,000 pounds are safely operated at highway speeds using this type of hitch system.

Devices including U.S. Pat. No. 5,899,655 to Miller and U.S. patent application 2001/0036395 to Talbott also attach to vehicle using the standard trailer hitch connection system. Herein described Lift System offers substantial advantages over these and other prior art because the large mass of the lifted object or Load is lifted to and transported in a central position in the truck bed. For transport, a centered, weight-forward position is much preferred as it distributes Load mass to all four tires, providing improved vehicle handling and control for all road surface and driving conditions. Certain previously developed lift and transport mechanisms position the Load up to two feet behind the vehicle rear bumper. This Load position defeats the preferred vehicle weight balance and may over stress the rear tires and suspension components and cause unstable and unsafe handing of vehicle.

The gear reduction Winch, using wire rope cable, is widely accepted as a simple and compact mechanism for pulling and securing heavy loads. The Motorcycle Lift and Transport System described here combines the proven function of the commercially available winch with a plurality of other engineered components to provide a unique, practical and highly efficient solution to lifting and transporting heavy Loads on a Pick-Up truck or other flat bed vehicle.

### SUMMARY

The invention, an improved Lift and Transport System enables one person, the Operator, to safely lift and transport an object or “Load”, weighing up to 1200 pounds. Large touring motorcycles with maximum load in side bags and trunk will weigh less than 1200 pounds. Said Lift System includes mechanisms to first secure the Load to a rigid frame, and additionally to guide and lift the Load up to Truck bed and additionally to slide the Load to the full-forward position in Truck bed. Said Lift System additionally includes mechanism to tightly fasten the Load to Truck Box for stable transport on highway. Said Lift System is totally self-contained and will attach to vehicle via standard receiver type trailer hitch. This type of hitch is standard equipment on many Pick-Up Trucks and other motor vehicles and provides a rigid and central mounting point for the described Lift System. The most common version of vehicle receiver hitch, a 2-inch square hitch is used for all depictions. Truck tailgate is detached and set aside to use said Lift System. Permanent modifications to Truck are not required to attach and use said Lift System. Invention is completely portable so that no permanent or obtrusive feature remains on vehicle when said Lift System is not in use. All necessary attachment hardware is included in Lift System. All component parts of said Lift System can be configured for storage inside the truck when not in use. Throughout this document the terms forward or front will always reference the direction toward vehicle front or driver's compartment of vehicle. The terms rearward or rear will always indicate the vehicle area furthest away from driver's compartment. The term bar will indicate a metal part that is cut to length from standard size stock such as bar-stock. The term plate will indicate a metal part which is cut or trimmed in length and height or a part that has one or more holes drilled in part.

### BRIEF DESCRIPTION OF THE FIGURES

FIG. 1—A perspective view, identifying main components and assemblies of the system. The front and rear tire and wheel assemblies 97 and 98 depict Load. Leader lines with arrows show assemblies that will be expanded in latter views.

FIG. 2—A perspective view, showing the main components of the system, including Load, in a Partially Loaded position.

FIG. 2A—A perspective view showing detail of cable routing for loading and relative positions of loading sub-assembly. Includes Component identification numbers.

FIG. 2B—A perspective view showing cable routing for loading with cable attachment method to Main Frame 4. Includes Component identification numbers.

FIG. 3—A perspective view having some parts or sections of parts removed for enhanced clarity. View shows Main Frame 4 with Load in the fully loaded and secured position.

FIG. 3A—A perspective view having some parts or sections of parts removed for enhanced clarity. View shows Main Frame 4 with Load in the fully loaded position with cable attached to begin unloading.

FIG. 3B—A perspective detail view having some parts or sections of parts removed for enhanced clarity. View shows cable position and routing at start of unloading.

FIGS. 3C, 3D, 3E, and 3F—Set of four perspective views of Main Frame 4 with Load and truck box showing sequential positions during loading process.

FIG. 4—A perspective view showing front section of truck box and Front Tire, Front Tire Clamp and Cross Bar Clamp. Includes Component identification numbers.

FIG. 4A—A perspective detail view showing part of Front Tire, Front Tire Clamp, and Cross Bar Clamp. Includes Component identification numbers.

FIG. 4B—An overhead view of truck box, Cross Bar Clamp and Main Frame 4 with Load.

FIG. 4C—An overhead detail view showing part of Front Tire, Front Tire Clamp, and Cross Bar Clamp. Includes Component identification numbers.

FIG. 5—A perspective view, showing alignment and positions of components attached to Truck hitch, prior to start of lifting.

FIG. 6—A perspective view of Hitch Frame 1 including component identification numbers.

FIG. 7—A perspective view of Roller Frame 2 including component identification numbers.

FIG. 7A—A perspective view of bottom of Roller Frame 2 showing both cable guide bearings and adjacent components.

FIG. 8—A perspective view of Winch Assembly 3 including component identification numbers.

FIG. 8A—A bottom perspective view of Winch Assembly 3 showing component identification numbers and relative positions of fasteners and related components.

FIG. 9—A perspective view of Main Frame 4 including component identification numbers.

FIG. 9A—A perspective detail view of bearing assembly that attaches to rear of Main Frame 4.

FIG. 10—A front perspective front view of Main Frame 4 including Front Tire Guide, Wheel Clamp, and features for Cable routing. Includes Component identification numbers.

FIG. 11—A right side view of Cross Bar Clamp 5 with section view of Truck box cap 8 showing Cross Bar Clamp 5 engaged to Truck box Cap 8. Includes Component identification numbers.

FIG. 11A—A perspective detail view of central region of Cross Bar Clamp 5. Includes Component identification numbers.

FIG. 11B through 11E—A set of four views, two overhead and two plan views, showing alternate positions of Cross Bar Clamp lock plates 101.

FIG. 12—A perspective view of a foldable version of Main Frame 4 showing hinging elements attached to top tube on each side of Main Frame 4.

FIG. 12A—A perspective detail view of a foldable version of Main Frame 4 showing hinging elements attached inside each side rail tube of Main Frame 4.

FIG. 13—A perspective view of a foldable version of Main Frame 4 shown folded for storage inside vehicle cab or elsewhere. Lower pair of connecting lugs shown with fastener removed.

FIG. 13A—A perspective detail view of a foldable version of Main Frame 4 shown folded for storage inside vehicle cab or elsewhere.

FIG. 14—Drawing Reference Numerals for items 20 to 53.

FIG. 15—Drawing Reference Numerals for items 54 to 89.

FIG. 16—Drawing Reference Numerals for items 90 to 114.

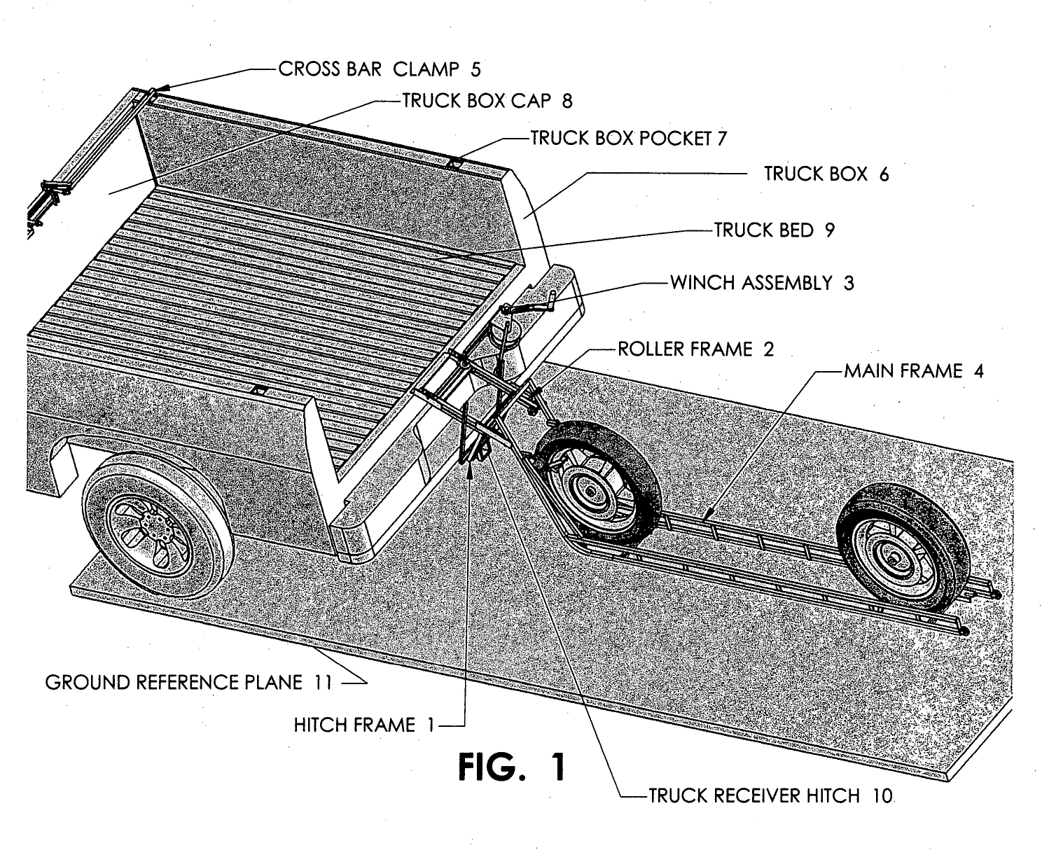

### DETAILED DESCRIPTION—FIGS. 1 THRU 13A—PREFERRED EMBODIMENT

A preferred embodiment of Lift and Transport System is shown in FIGS. 1 thru 13A. This preferred embodiment describes the lifting and transport of a two-wheeled motorcycle. However this Lift System is easily adaptable to lift many other sizes and shapes of objects. Changing the size and shape of Main Frame 4 and the interfaces between Load and Main Frame 4 will allow lift and transport of a plurality of other devices including but not limited to All-Terrain Vehicles (ATV's), Snowmobiles, Lawn Mowers, Tillers, Appliances, etc. All other components of lift system are suitable, as described below, to lift and transport these and many other devices. The terms Load and Motorcycle are equivalent in this document, Load being used in the more generic instances.

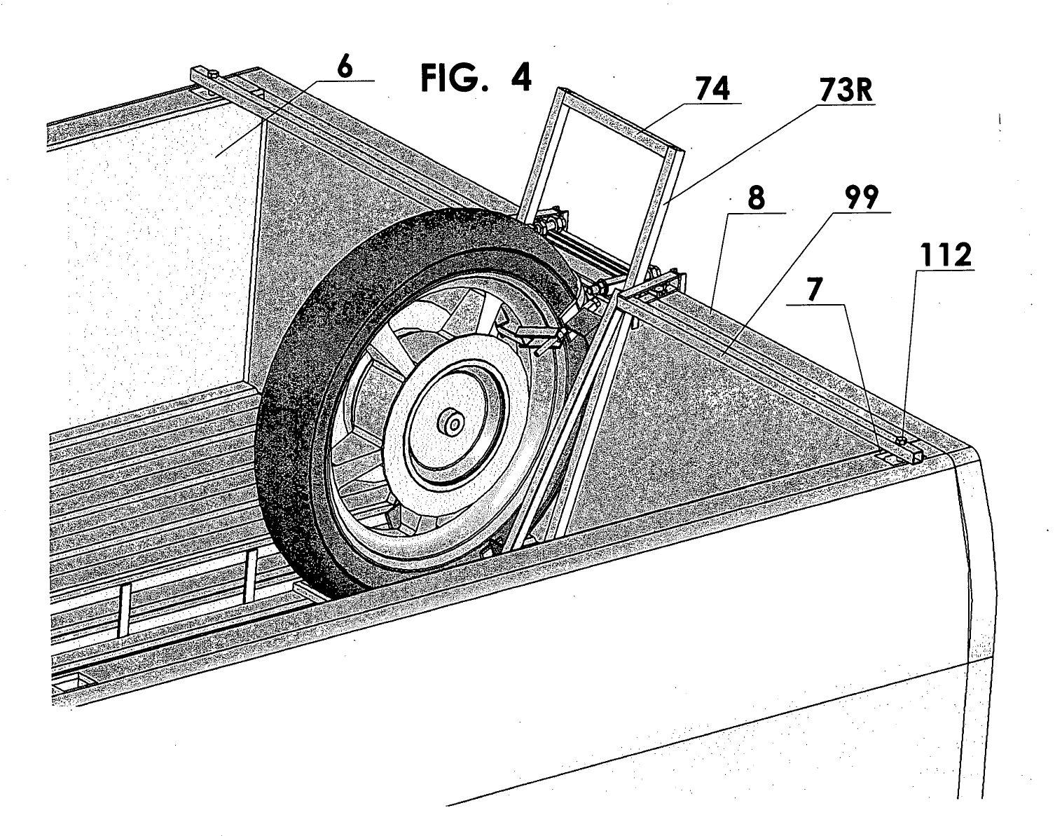

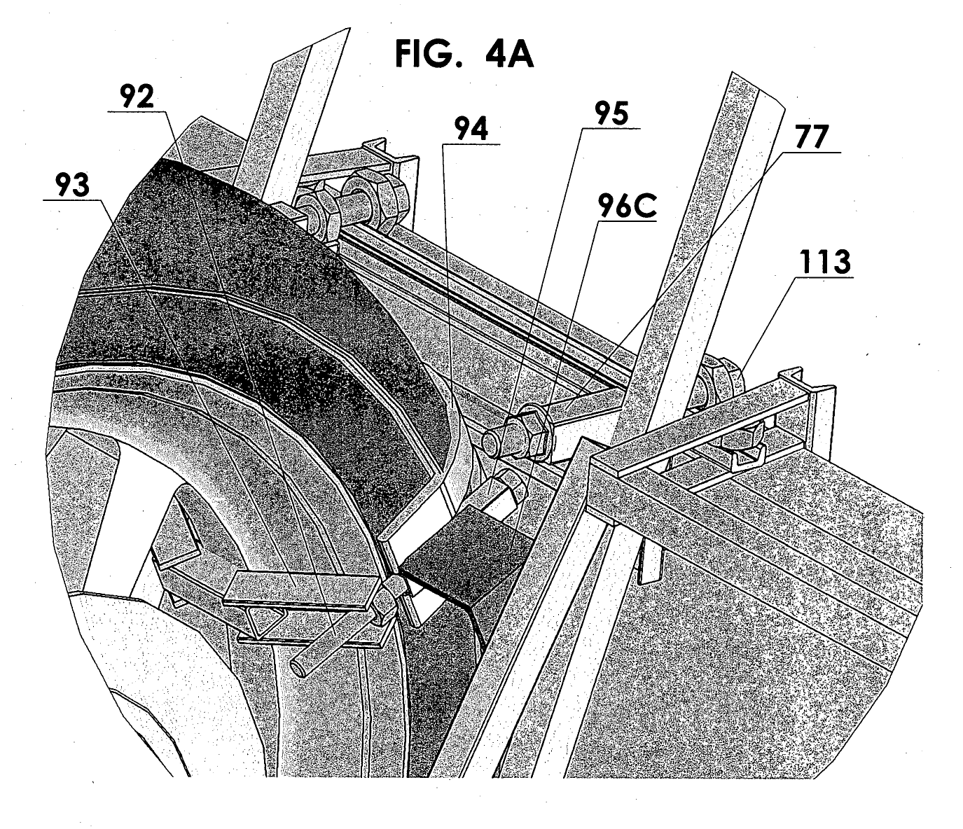

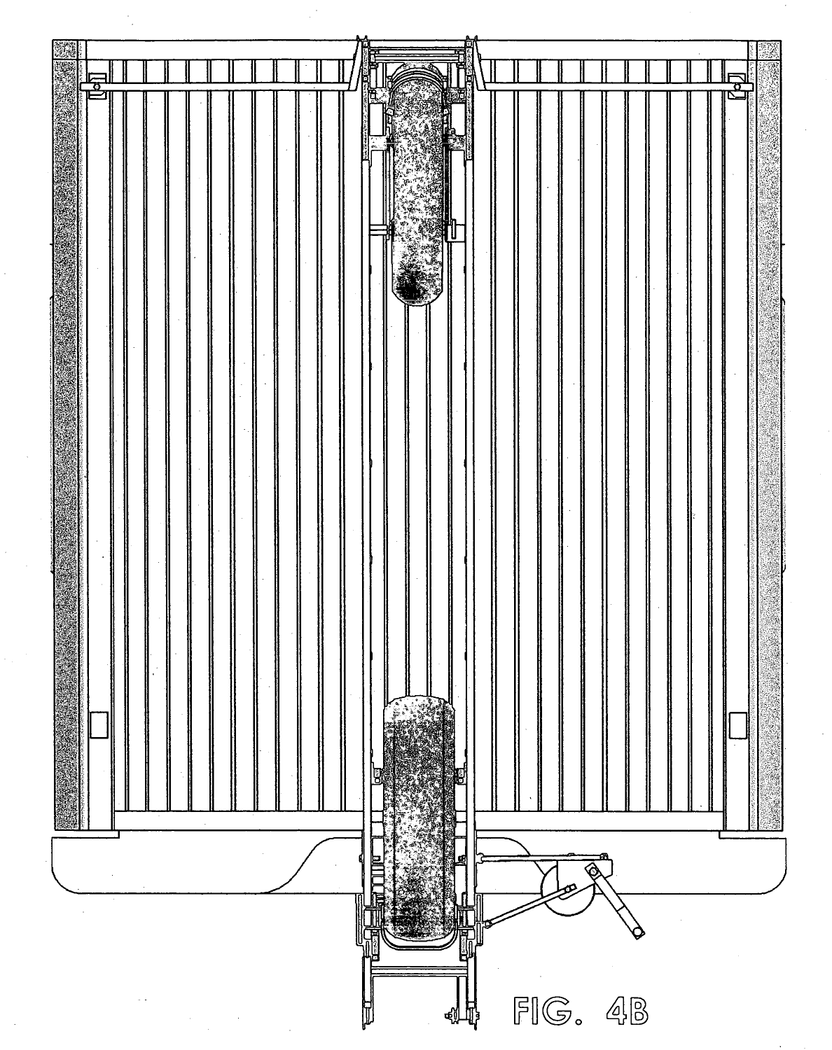

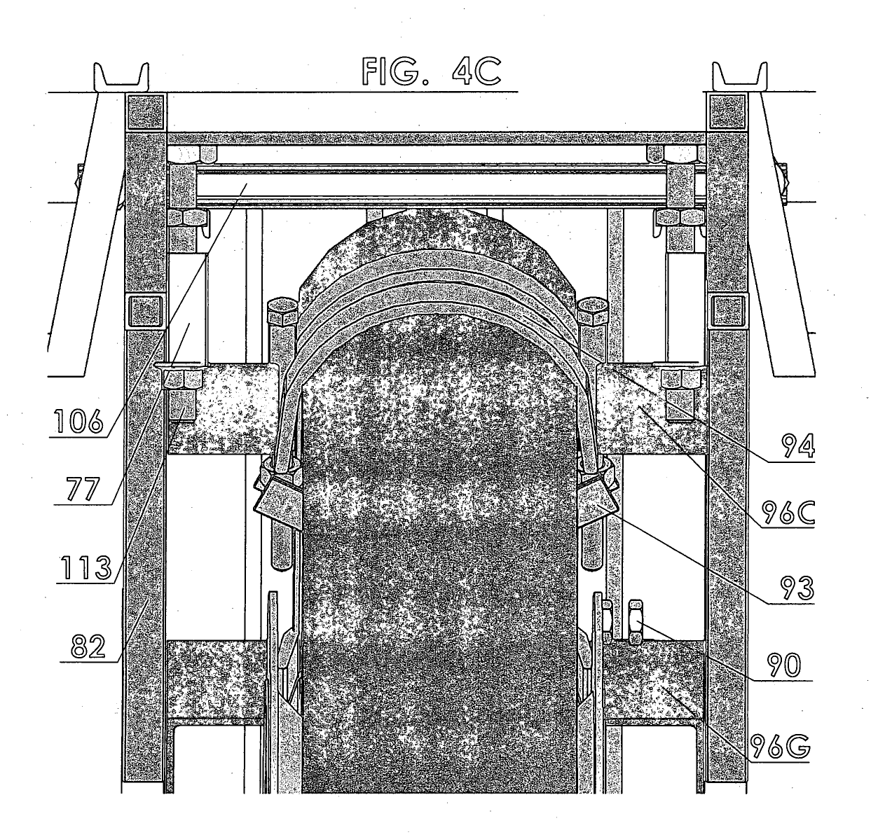

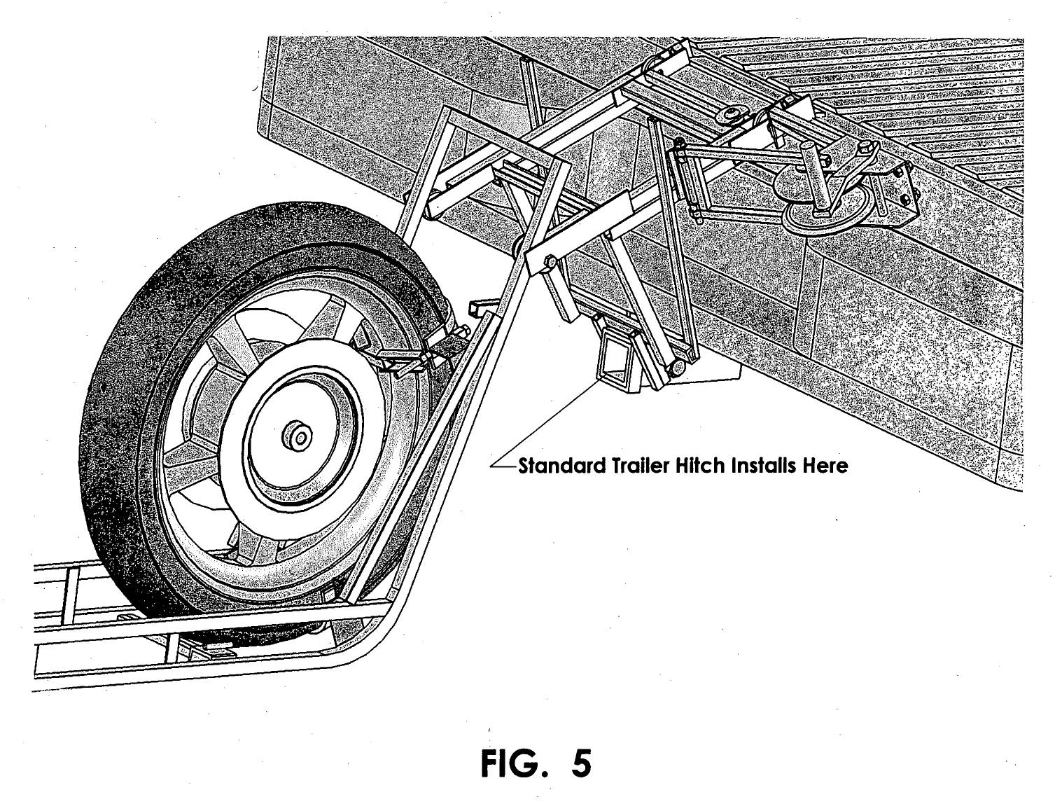

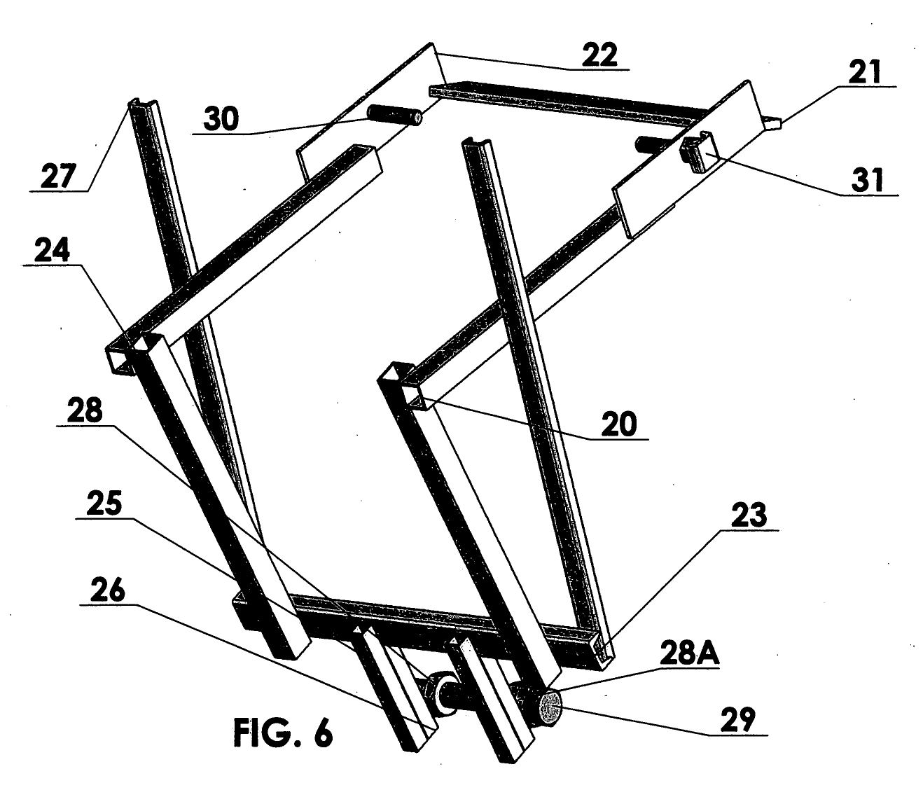

FIG. 1 includes identification numbers and names of truck parts and Lift System assemblies. FIGS. 1 through 3F show Main Frame 4 with Load in Unloaded, Partially Loaded, and Fully Loaded positions. FIGS. 4, 4A, and 5 provide detail views to enhance the understanding of alignment and clamping features of System. FIGS. 6 thru 11 provide further detail and component identification for assemblies from FIG. 1. Part numbering scheme assigns a unique name and number to each component of the five main assemblies starting with Hitch Frame 1 and ending with Cross Bar Clamp 5. Component parts having multiple references are typically shown only once with respective number.

Lift System attaches only to Front Wheel and Tire Assembly 97 and Rear Wheel and Tire Assembly 98, therefore the size and shape of motorcycle body, engine and frame is not critical and is not depicted. Main Frame 4 is made longer or shorter to fit any motorcycle wheelbase. On all drawings components may be removed or made transparent to provide best possible detail and understanding of primary components in said view.

Hitch Frame 1 is a rigid lightweight welded structure welded at all part interfaces as shown in FIG. 6. Channel 23 is the structural base for this assembly. Channel 23 contacts truck receiver hitch 10 and supports a majority of Load mass. Tubes 24 are welded flat against wide edge of channel 23 on a plane generally upward and slanting rearward from truck rear bumper. Tubes 25 are welded flat against the wide edge of channel 23 and extend below channel 23. Tubes 26 are welded to tubes 25 and to the narrow edge of channel 23. Horizontal spacing between pairs of tubes 25 and 26 is equal to width of truck receiver hitch 10 at its widest point, usually the collar around rear end of receiver hitch 10. Hex nuts 28A are welded together then threads are removed to form a bushing surface. Hex nut 28 is welded to front side of one tube 26. Hex nut 28A is welded to other tube 26. Width between hex nuts 28 and 28A is set to just exceed width of main tube section of truck receiver hitch 10. Final welded position of hex nuts 28 and 28A to tubes 26 determine fixed angle of tubes 24. Required angle for Tube 24 will vary based on key vehicle measurements. Height of receiver hitch 10 from ground and height of truck bed 9 from receiver hitch 10 are of particular importance and vary substantially in today's truck market.

Tubes 20 are welded to tubes 24 and plates 22 are welded to tubes 20. Bar 21 is welded at right angles to plates 22. Bar 21 sets flatly on Truck Bed 9 to provide additional rigidity and reduce Load mass acting directly on Receiver Hitch 10. Angle between tubes 20 and tubes 24 is set such that bar 21 will set flat on to truck bed 9. Bolt 30 provides one side of a pivotal axis at center of bearing 43L and Roller Frame 2. Bolt anchor 31 is made from bolt similar to bolt 30 with a short piece of channel iron welded to head of bolt. Bolt anchor 31 provides other axis point for Roller Frame 2 at center of bearing 43 and also provides anchor for bar 66 part of Winch Assembly 3. Channels 27 are welded to channel 23 and also welded to tubes 20. Inside surfaces of channels 27 provide lateral constraint for Roller Frame 2 as it pivots about bolt 30 and bolt anchor 31.

Hitch Frame 1 attaches to outside and top surfaces of truck Receiver Hitch 10. Hitch Frame 1 fits tight against sides of Receiver Hitch 10. Hole in hex nut 28 and hex nuts 28A aligns with hole in Receiver Hitch 10. Bolt 29 inserts through hex nuts 28A and through receiver hitch 10. Hitch Frame 1 is secured to truck receiver hitch 10 when bolt 29 is tightened into hex nut 28. Designed thusly Hitch Frame 1 is both lightweight and very rigid while remaining highly configurable to fit the plurality of vehicle bed heights and hitch positions seen in today's market.

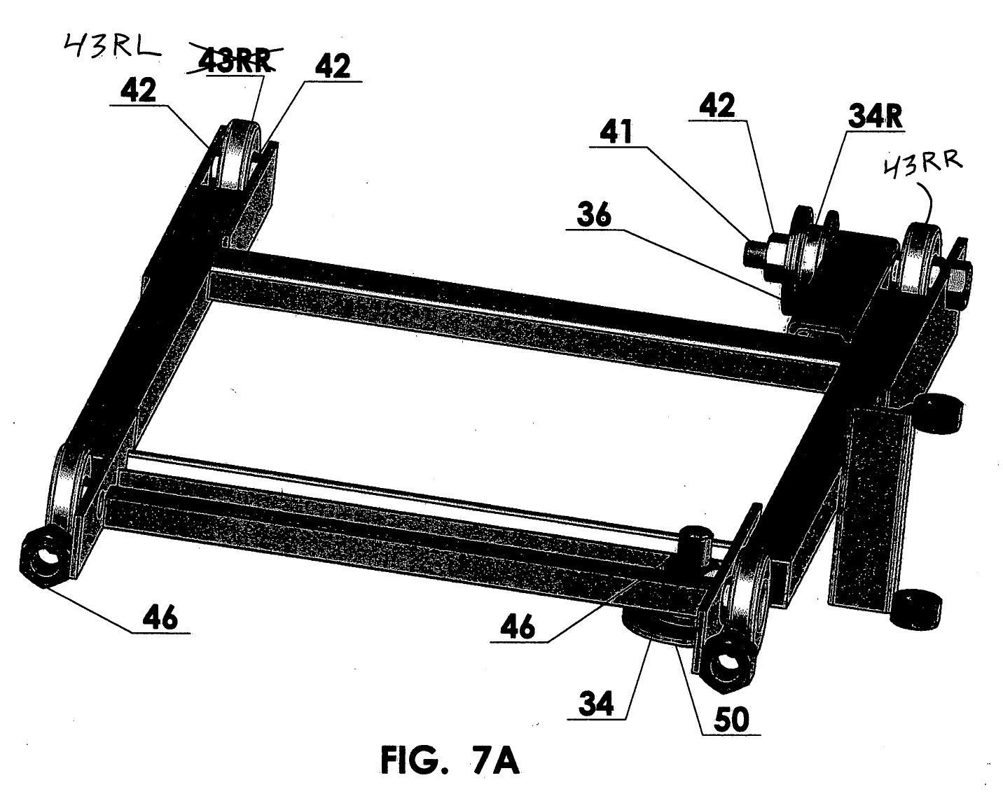

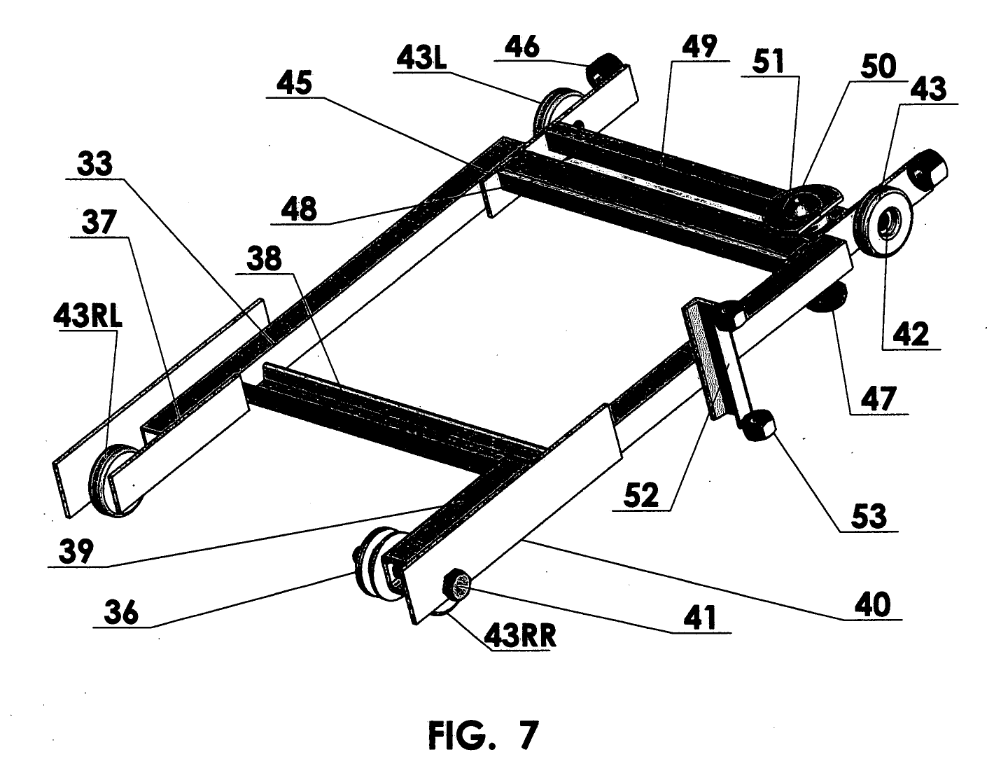

Roller Frame 2 attaches to Hitch Frame 1 using bolt 30 and bolt anchor 31 as described above. Roller Frame 2 is a ladder design frame the sides of which are formed by tubes 33. Channel 38 is welded at right angles to tubes 33 near rear of tubes 33. Heavy wall tube 39 is welded to tube 33 on one side and to channel 38 on one end per FIG. 7A. Plates 40 are welded to outside of tubes 33 and extend beyond end of tubes 33 to provide lateral constraint for Main Frame and Load. Bolt 41 provides mounting axis for bearing 43RR and bearing 34R. Tube 39 is drilled for bolt 41 to pass through and tube 39 acts to stiffen bearing mount and prevent twisting as lifting force is transferred from cable 70 into bearing 34R. See FIG. 7A. Each plate 45 is welded to tube 33 with some overlap as shown in FIG. 7. Hex nut 46 is welded to plate 45 such that hex-tip of nut 46 will be at same planar position as top surface of bearings 43, 43L, 43RL and 43RR. Channel 48 and tube 49 are welded at both ends to plates 45 spaced such that thick hex nut 46 will just fit between them. Hex nut 46 is welded in said position to tube 49 and channel 48 keeping top surfaces of all parts flush. Bolt 51 is placed into washer 50 and bearing 34 and threaded into hex nut 46 until just snug. Hex nut 47 is threaded onto bolt 51 then tightened against hex nut 46 to lock components into said position._Channel 52 is welded to side of tube 33. Hex nuts 53 are welded to each end of channel 52. Using the above described design and assembly methods Hitch Frame 2 will be seen as a precision yet inexpensive assembly. Said precision is proven as the top surfaces of bearings 43, 43L, 43RL and 43RR are positioned substantially on one plane to provide a stable base for Main Frame 4 with Load to roll across.

A unique method is used to attach bearing 43RL to plates 40 and 37. Through rigorous testing it is known that hex nut 42 which is a metric M10 nut will press fit into bearing 43RL and many other bearings having 0.750 inch bore. To mount bearing 43RL one hex nut 42 is welded at correct position on plate 40. Another hex nut 42 is welded in correct position to plate 37. Weld bead may protrude onto surface of hex nut 42 because only about one half of surface width of hex nut 42 will be pressed into bearing 43RL. Weld may also be applied to inside of nut 42 since nut 42 is only a few millimeters thick and internal threads are not used for this mounting method. A sub-assembly is made from plate 37 with welded on hex nut 42 and pressed on bearing 43RL. Said sub-assembly is centered over welded on hex nut 42 of plate 40. Plates 40 and 37 are pressed together with c-clamp or vice until plate 37 contacts tube 33. Plate 37 is welded to tube 33 and process is complete. Contact occurs only between bore of bearing 43RL and the six hex-tips of hex nut 42 producing a solid assembly without using excessive press force.

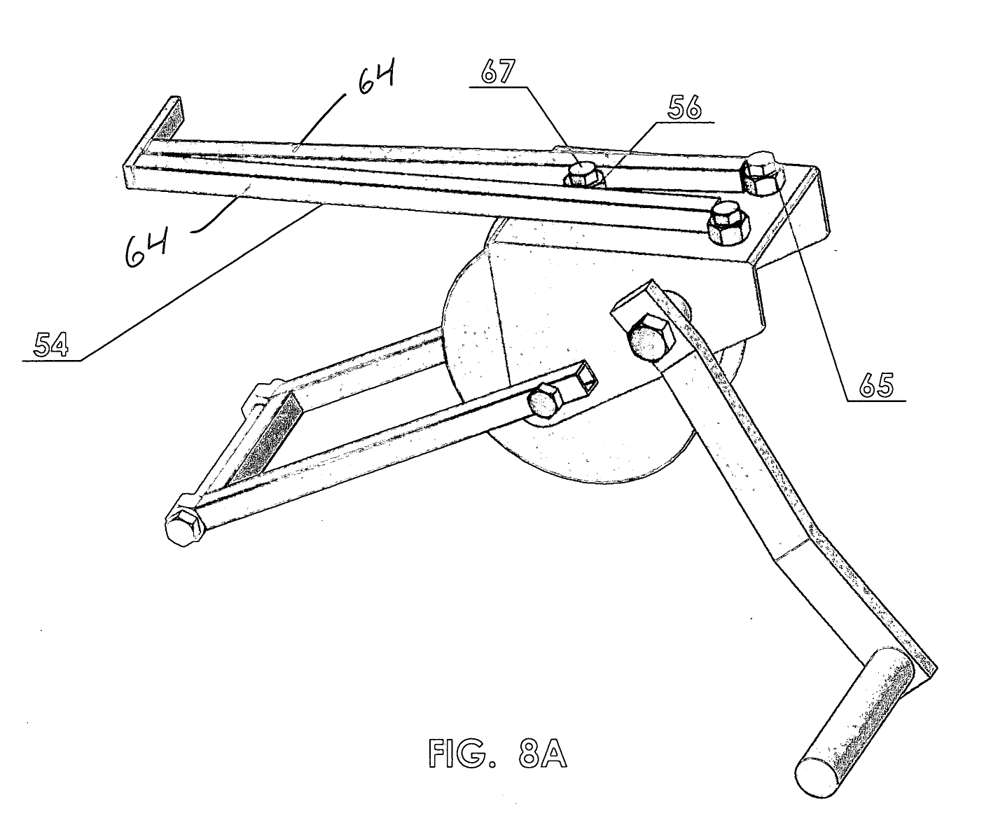

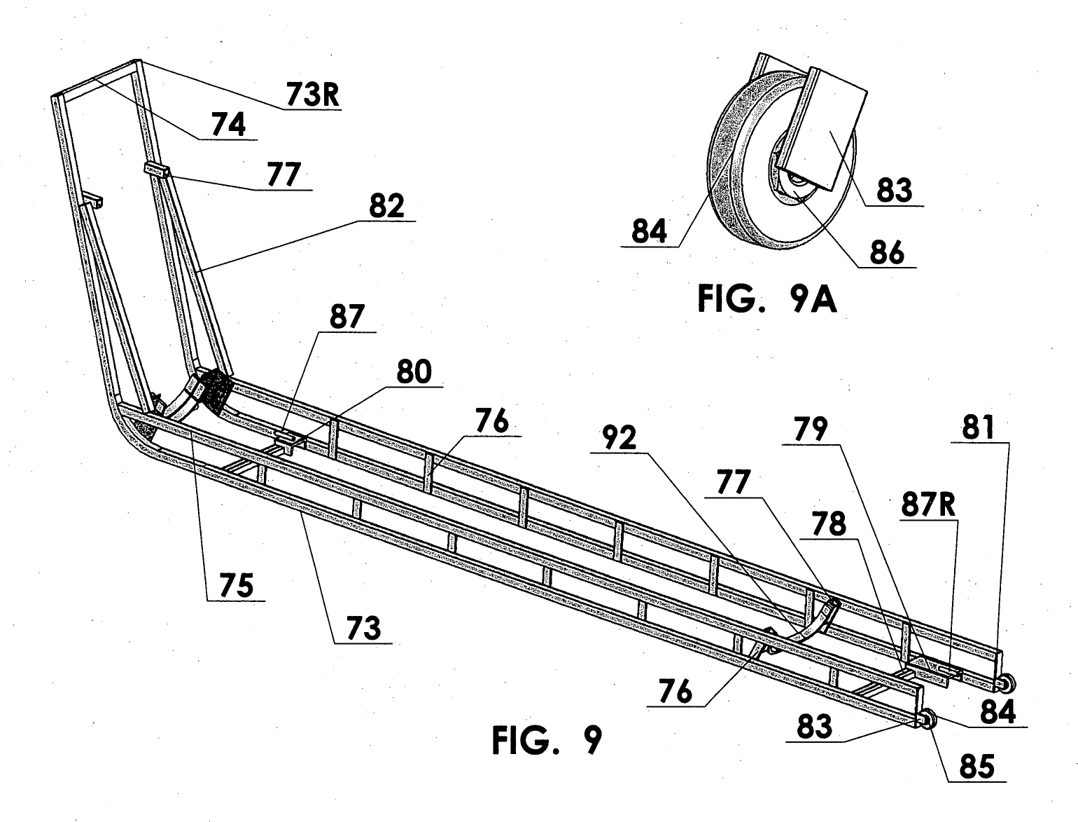

Bearings can thusly be affixed in a precise and desired position on any plate or flat steel surface without drilling any hole in the plate or flat steel surface. This method is well suited for roller and conveyor type applications and saves the cost hole drilling through two steel plates, machined bushing, axis bolt, and lock washer. Said bearing attachment method is also used to locate rear bearings 85 on Main Frame 4 as shown in FIG. 9A. One additional benefit of this assembly method is proven as bars 83 in FIG. 9A are positioned closer together than plates 40 and 37 described above. Using this method plates may be positioned from less than 0.5 inches apart to nearly 1.5 inches apart simply by choosing different standard versions of M10 hex. Jam nut 86 affords the thinnest such version. Regular nut 85 is standard width, a thick hex nut not used here is also available all having the same outer diameter. For assemblies as in FIG. 7A where bolt is used to hold multiple components on one axis hex nut 42 may have threads removed prior to pressing hex nuts 42 into bearing 43RR. Used in this manner the hex nuts 42 become a low cost replacement for a more costly precision bushing.

The Lift System herein proposed uses the common hex nut to yield additional unique and cost effective assembly methods. Standard assembly method to produce a linkage arm or bracket is to drill two holes in the base steel part having a measured and precise distance between said holes. Lift System herein proposed improves on this standard method for a plurality of applications by positioning two hex nuts at a correct distance apart then welding the base steel part, cut generally to fill the space between nuts, to said hex nuts. Using this method no drilling is required. Hex nuts may be sized to either engage threads of mating fastener or to just slip over mating fastener as in a bushed fit as hex nuts are available in the market having a great variety of thread bore diameters. This method is especially appropriate when said final assembly will be held in place with a threaded fastener, as any looseness of fit is removed when said fastener is tightened. The cost of two hex nuts is generally insignificant and in all cases much below time and effort required to drill two precisely positioned holes through steel base material, Assemblies such as the proposed Lift System have a multitude of interfaces. Efficient design and assembly methods as described above must be protected as the best tool remaining for the individual or small entity builder to provide a cost competitive and attractive final product in today's market.

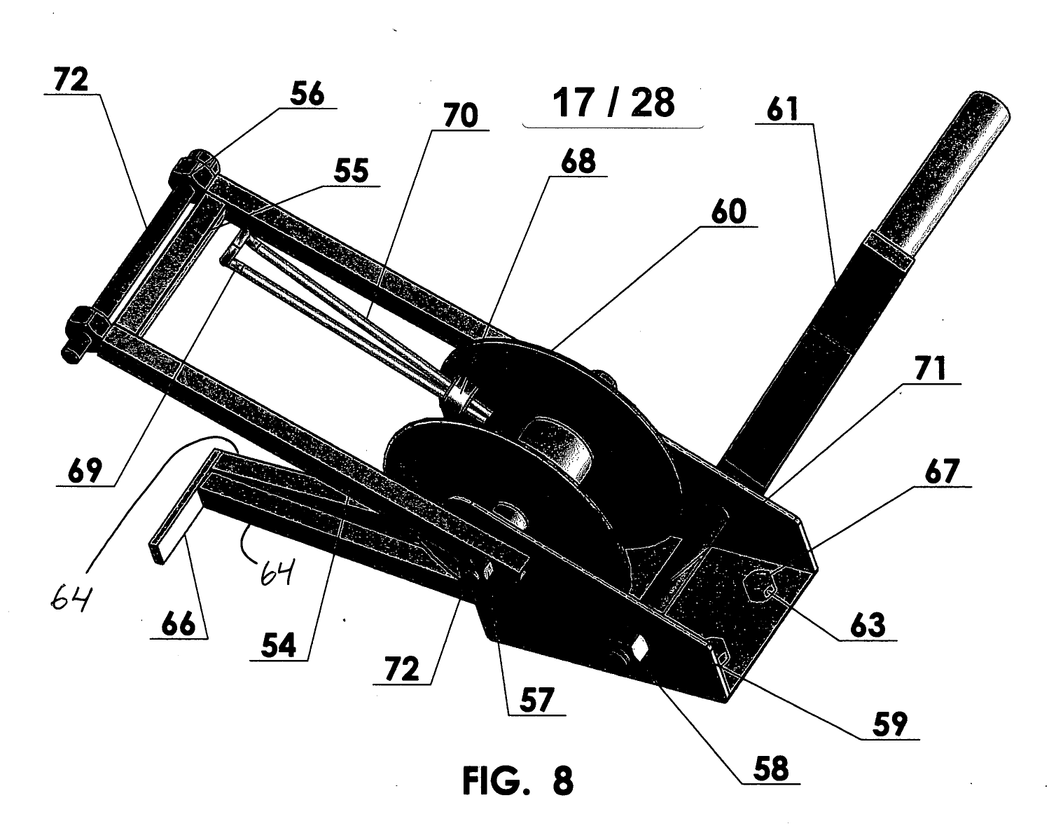

Winch Assembly 3 includes two simple tubular frames attached to a common hand winch as shown in FIG. 8. Hand winch would be purchased and used as a complete unit and breakdown here into component parts does not suggest otherwise. A tubular base is configured per FIG. 8A with tubes 64 welded together at one end. At said end also bar 66 is welded to both tubes 64. Nut 56 is welded to both tubes 64 and nut 65 is welded at free end of each tube 64. Attachment to winch housing 59 is made using hex bolts 67 and hex nuts 63 completing tubular base. Tube 55 is welded at right angles to each tube 54. Nut 56 is welded to end of each tube 54 such that outer surface of each nut 56 is flush with outer surface of each tube 54 as shown in FIG. 8. At other end of each tube 54 a hole is drilled one inch from end of tube 54 to accept 0.375″ diameter bolt 72. Bolt 72 is held in place with nut 57.

Winch Assembly 3 is fixed into its operational position as bar 66 is set into channel 31 and bolt 72 is set through hex nuts 56 and 53 after hex nuts 56 are centered outside of hex nuts 53. Winch Assembly 3 will thusly become part Roller Frame 2 expressly so cable 70 of Winch Assembly 3 will remain in optimal alignment with bearings 34 and 34R regardless of attitude of Main Frame 4. This construction is shown in FIGS. 7 and 7A. The complete assembly will rotate about axis of bolt 30 and bolt anchor 31.

Referring to FIG. 9, Main Frame 4, a reinforced weldment of substantial stiffness is constructed primarily of lightweight steel tubing. Main Frame 4 has a front end which may be secured or clamped to the truck box cap 8 after the load has been properly positioned in the box. Main Frame 4 also has a rear end where bearings or wheels 84 may be optionally attached. Tubes 73 and 73R define an upwardly extending portion which provides lateral support for the Load. Tubes 73 and 73R also defines bottom and outside shape for Main Frame 4. Tube 75 sets above tube 73 and 73R and is connected to tube 73 and 73R by a series of steel bars 76. Bar 81 is welded vertically at rear or tube 73 connecting tube 73 and tube 75 and also vertically at rear of tube 73R connecting tube 73R and tube 75. Each bar 76 is welded at right angles connecting tubes 75 to 73 on one side, and tubes 75 to 73R on opposite side. This construction method provides the desirable level of longitudinal stiffness. Two tubes 78 are welded to channel 79 flush at rear and bottom surfaces as shown in FIG. 9. Pin 87R is welded to top of channel 79. Channel 79 is welded to tube 73R. Other end of tube 78 is welded to tube 73. Tubes 78 serve as support for Rear Tire and Wheel 98. Channel 80 is welded to tube 73R. Pin 87 is welded to top of channel 80. Tubes 78 are welded to side of channel 80 flush to front of channel 80. Other end of tubes 78 is welded to inside of tube 73 to create support for Front Wheel and Tire 97. Tube 82 is welded to each tube 73 and 73R and short tubes 77 are also welded to each tube 73 and 73R at top of each tube 82. Tube 74 is welded to each tube 73 and 73R to provide a top crossbar between tubes 73 and 73R. Thusly constructed, superior stiffness without bulk is provided to all sections of Main Frame 4.

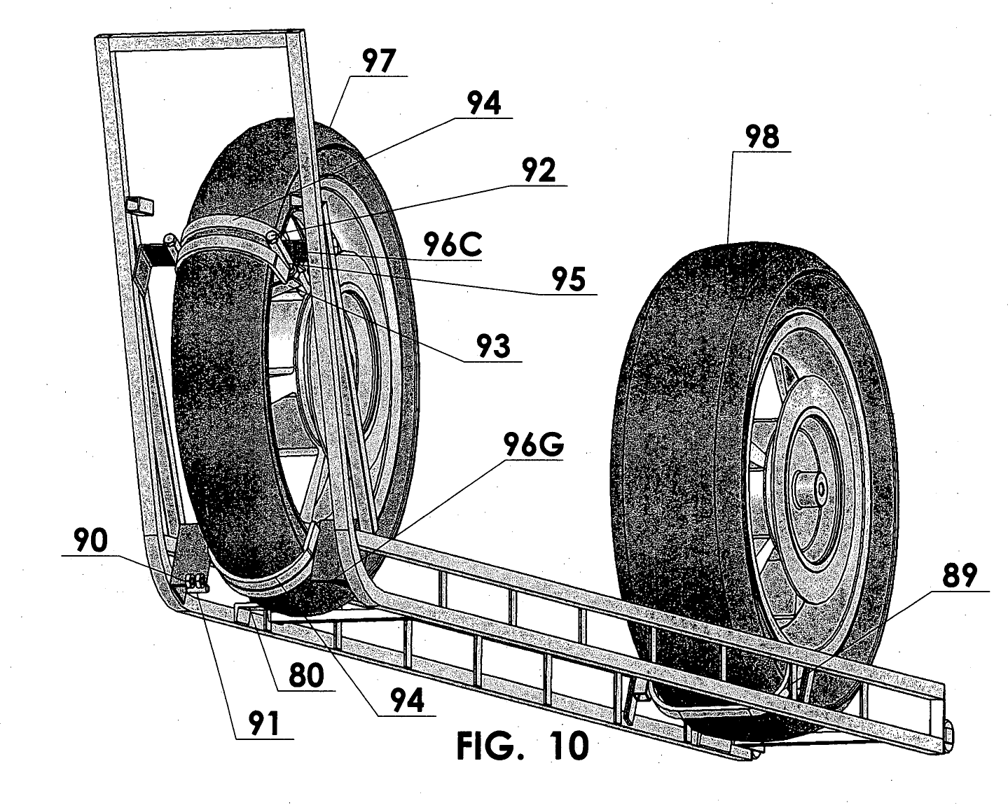

Angle 96G is welded to each side of Main Frame 4 contacting both tubes 73 an 75 on one side and tubes 73R and 75 on other side. Bar 94 is welded to each side of each angle 96G as shown in FIG. 10. Main Frame 4 also includes feature to constrain Motorcycle from front to rear and up and down motion. Angle 96C is welded to both tubes 73 and 82 on one side and to tubes 73R and 82 on other side. Tube 95 is welded to edge of each angle 96C. Bar 94 is welded to each side of tube 95. Tube 95 is sized such that hex bolt 92 will slip into tube 95. Front Wheel Clamp 93 attaches over wheel surface with bolts 92 and will lock Front Wheel and Tire 97 securely to Main Frame 4. Thusly Front Wheel and Tire will be constrained after motorcycle is rolled fully forward in Main Frame 4. Rear Wheel and Tire 98 is laterally constrained also by Rear Tire Guide 89; This clamping method prevents side-to-side movement of Tires and Motorcycle within Main Frame 4 during transport. This clamping method fully isolates Load from lifting and pulling stresses as these stresses are applied to and remain within Main Frame 4, isolating the sensitive component parts of Load from these potentially damaging stresses.

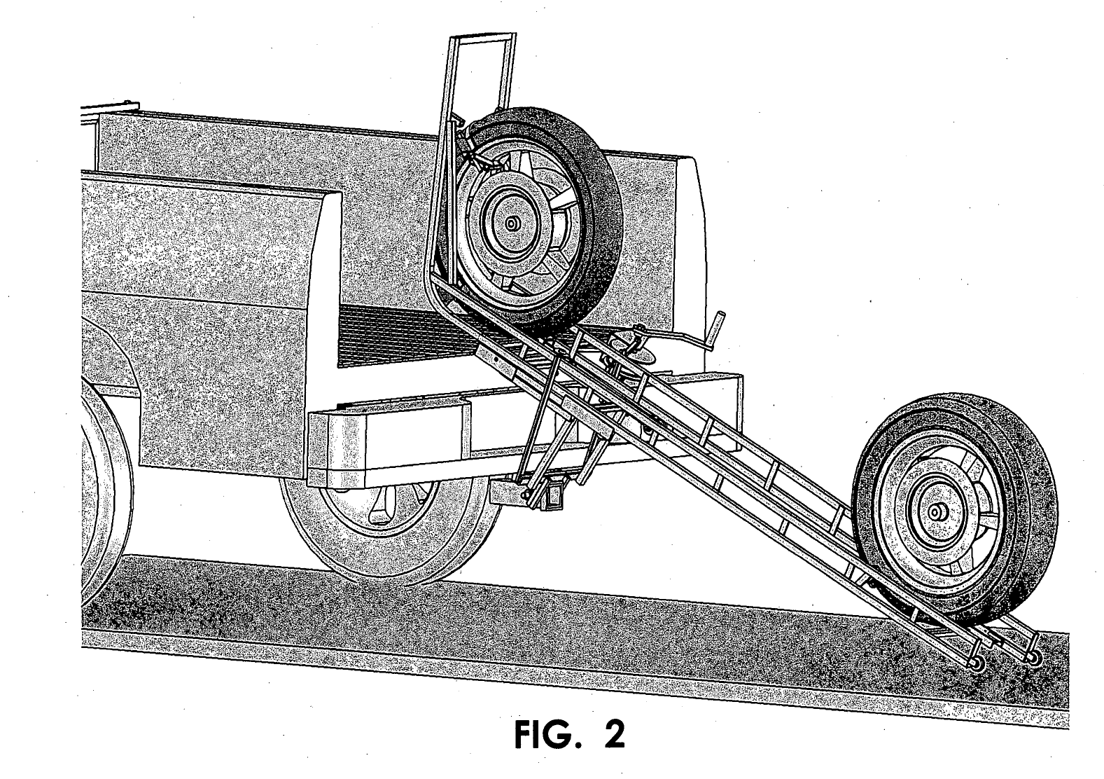

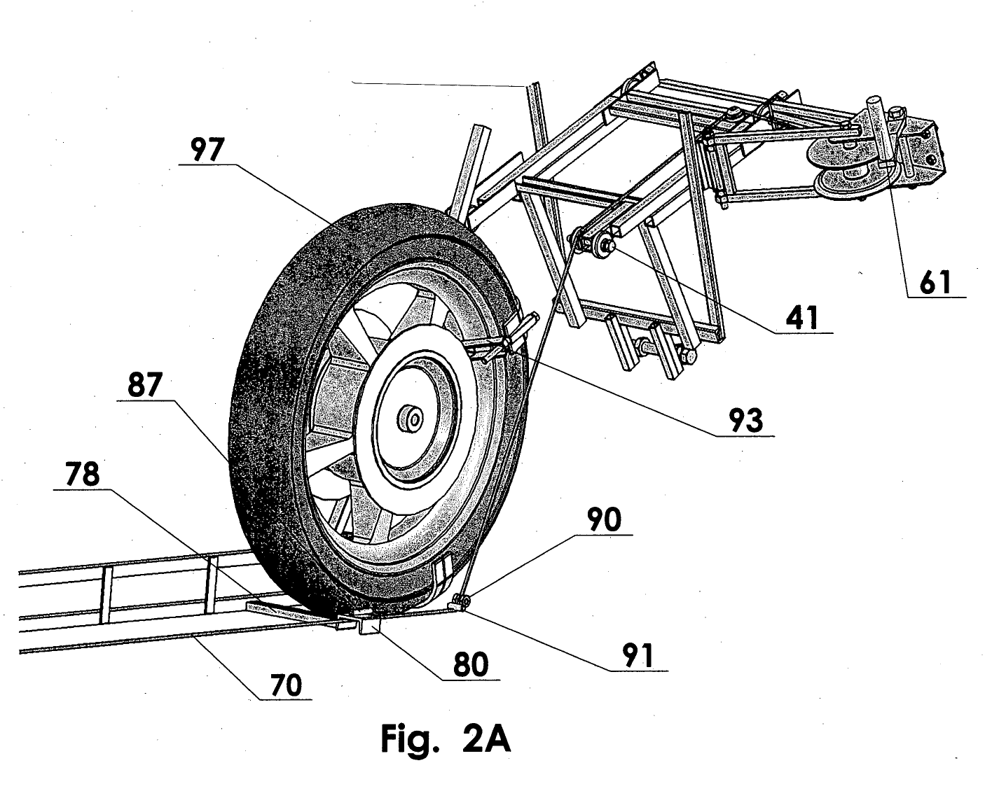

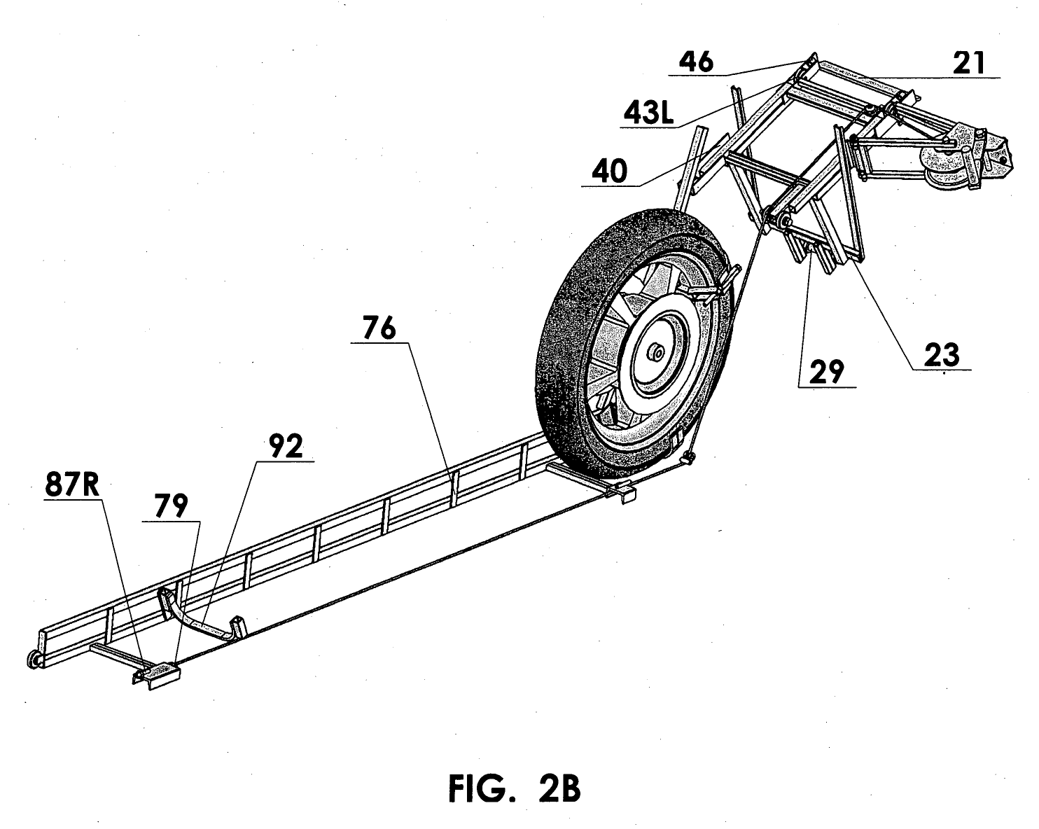

Winch Assembly 3 contains adequate length of high strength Steel Cable 70. Cable 70 has formed end loop 69 for fit to pin 87 and pin 87R. End loop 69 of cable 70 is formed by attaching crimp sleeve 68 a few inches up from end of cable 70 per FIG. 8. Per common practice a hand winch provides two cable wind options: 1) Ratchet-Lock, where Cable 70 is ratcheted inward in short increments and locked against unwinding as handle 61 is rotated and 2) Free-Spool, where Cable 70 unwinds freely with no ratchet action. In Free-Spool mode Cable 70 will unwind without resistance from Winch Assembly 3. Cable routing path for loading begins at hub 60 of Winch Assembly 3, continues below washer 50, around top Bearing 34 then rearward to bearing 34R between Washers 36 then down between guide nuts 90 over pin 91 through Channel 80 and also through Channel 79. Cable End Loop 69 fits around Pin 87R welded to top of channel 79. See FIGS. 2A and 2B for cable routing path for loading operation and FIGS. 7, 7A, and 8 for component location detail.

Winch handle 61 is held in place by bolt 71 and hex nut 58. Rotation of handle 61 causes pulling force to act through Cable End Loop 69 on to Main Frame 4 at pin 87R on top of Channel 79. Main Frame 4 cannot move forward due to contact with bearings 43RL and 43RR. Pulling force of cable 70 acts on bottom edge of Pin 91 to pull Main Frame upwards, keeping Main Frame 4 with Load in contact with rear bearings 43RL and 43RR.

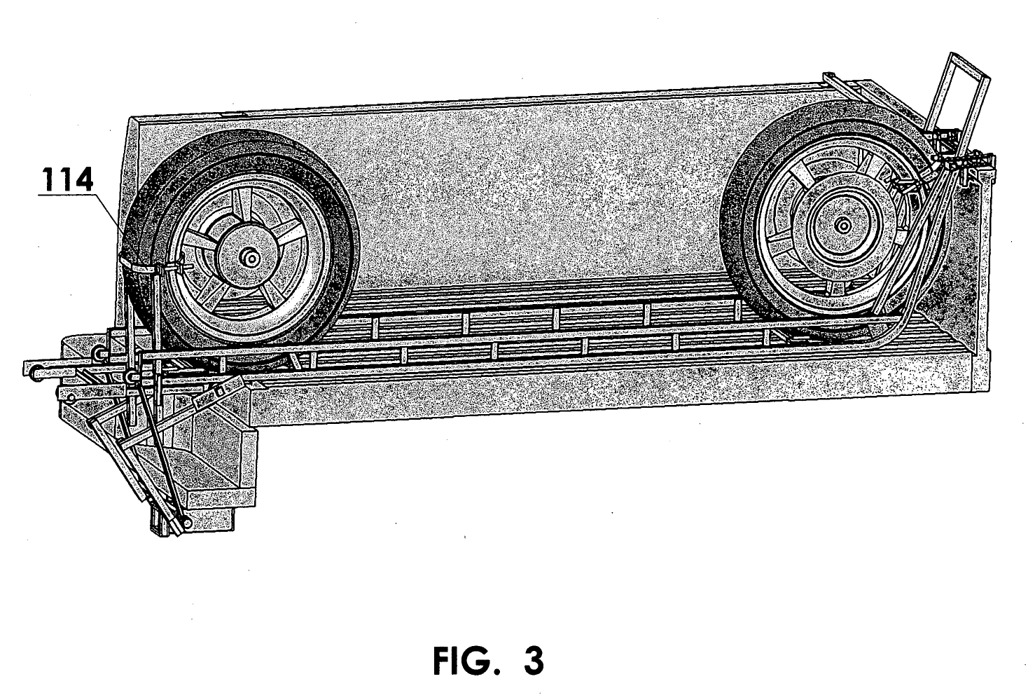

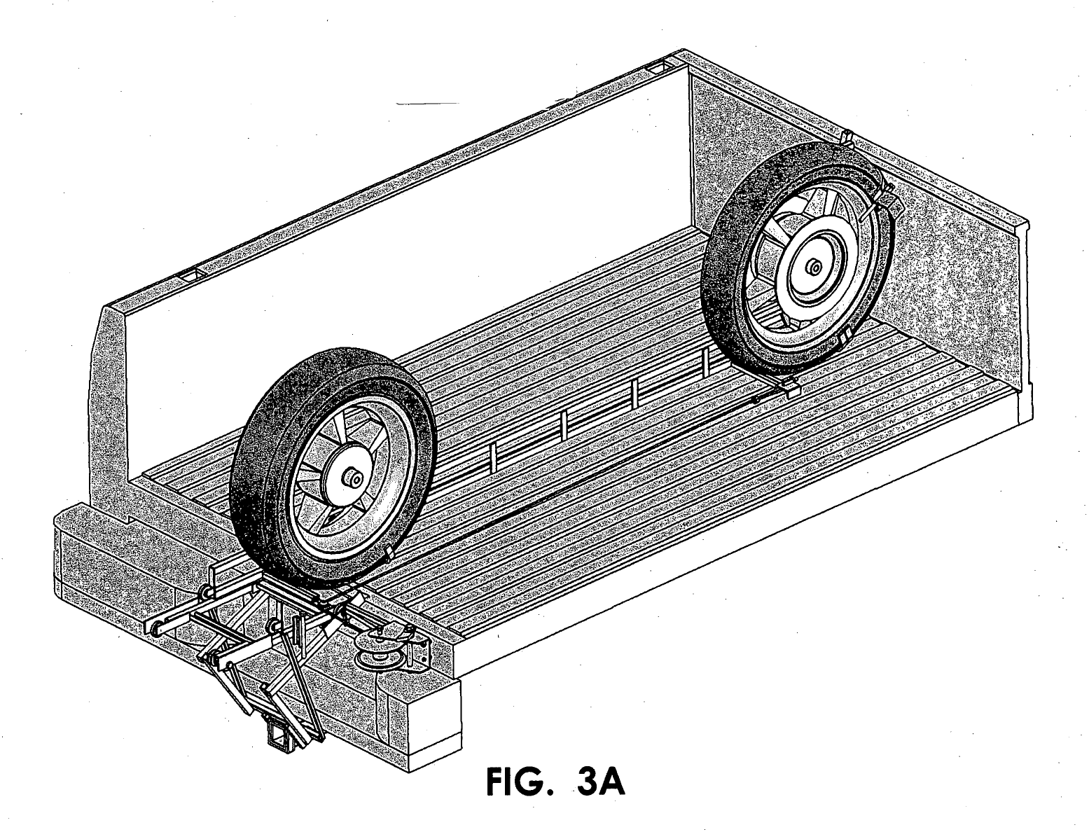

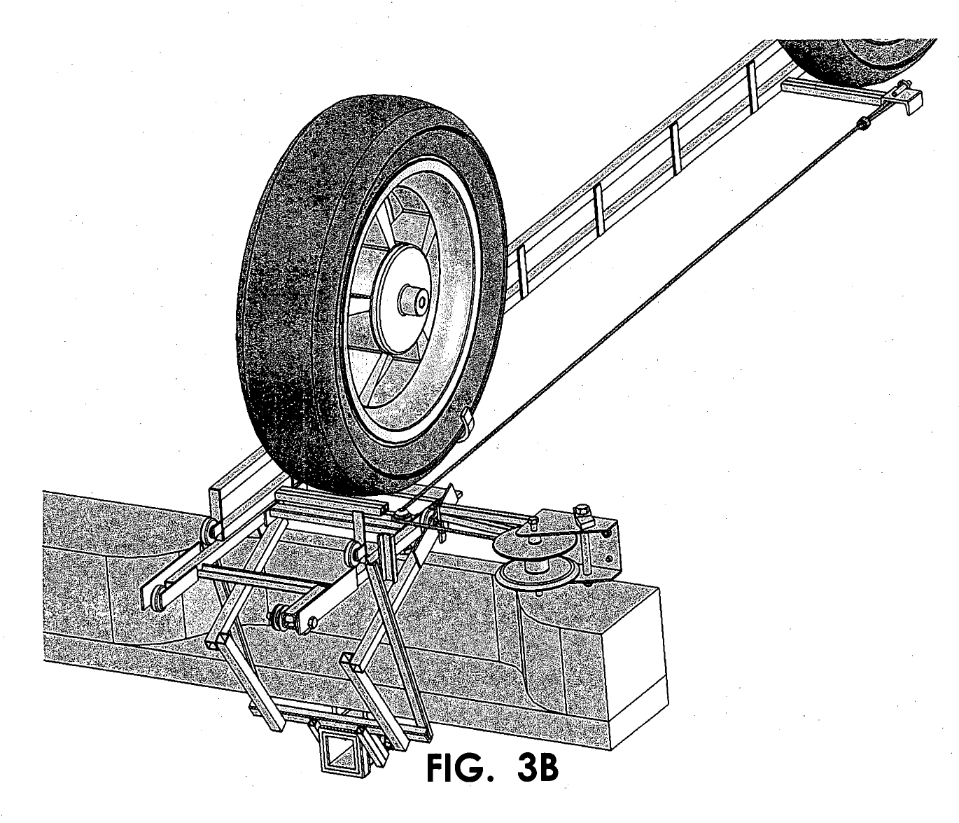

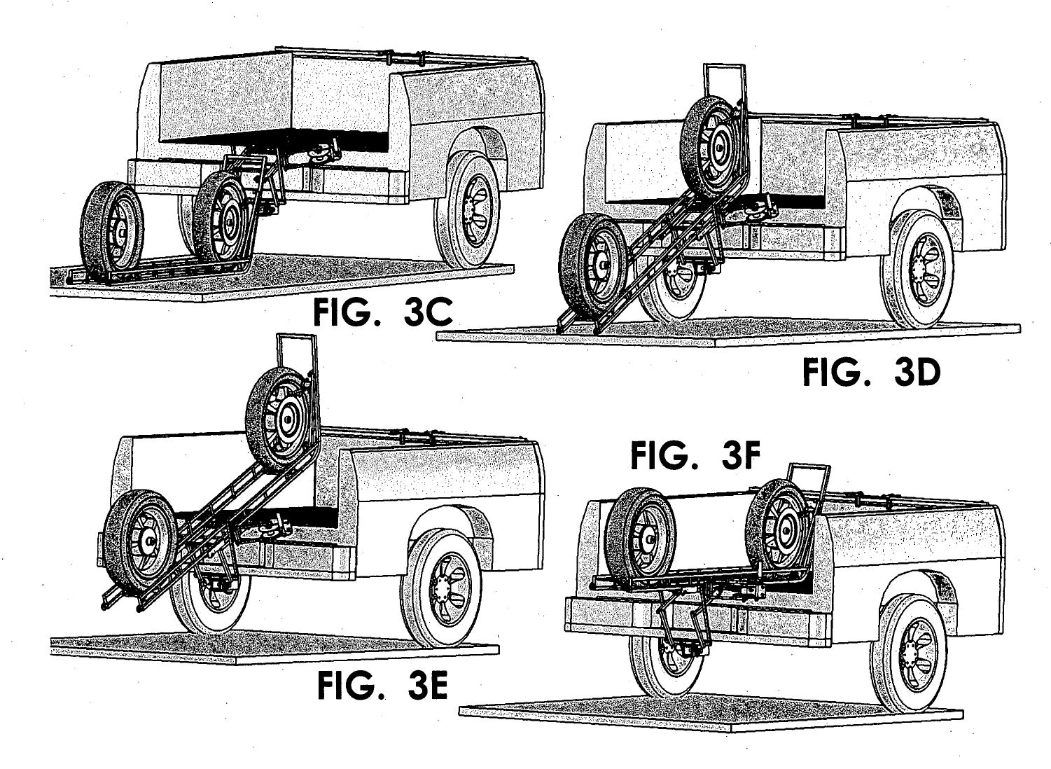

Design of Main Frame 4 supports Load up to 1200 pounds. Main Frame 4 with Load is not raised vertically but pulled against rear bearings 43RL and 43RR causing Load mass to be raised with minimal friction as Winch Assembly 3 is operated in Ratchet-Lock mode. As Main Frame 4 and Load move upward only bearings 43RL and 43RR are engaged. After about 24 inches of travel the curved lower surface of Main Frame 4 near bottom of Front Tire 97 will pass over bearings 43RL and 43RR. At this point the direction of travel for Main Frame 4 with Load will become less vertical and follow generally along the plane created by top surfaces of bearings 43, 43L, 43RR and 43RL. Continuing operation of Winch Assembly 3 will move Main Frame and Load to the position shown in FIG. 2. Soon thereafter the ground engaging bearings 84 will lift from ground plane. Main Frame 4 with Load will be completely supported and aligned by Roller Frame 2 and Hitch Frame 1 as shown in FIG. 3E.

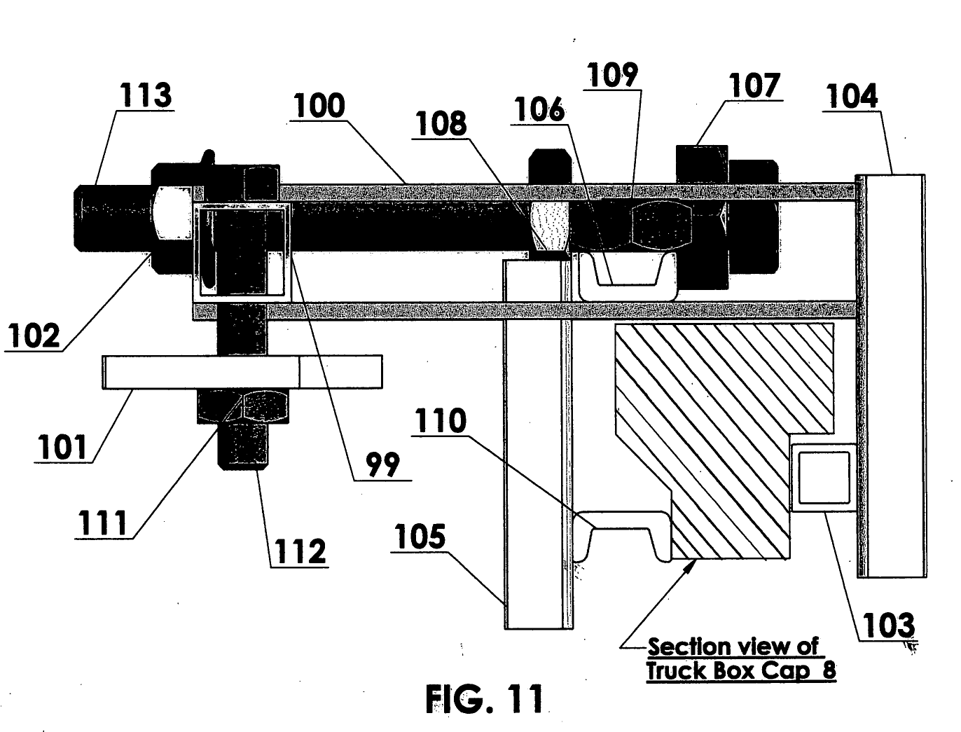

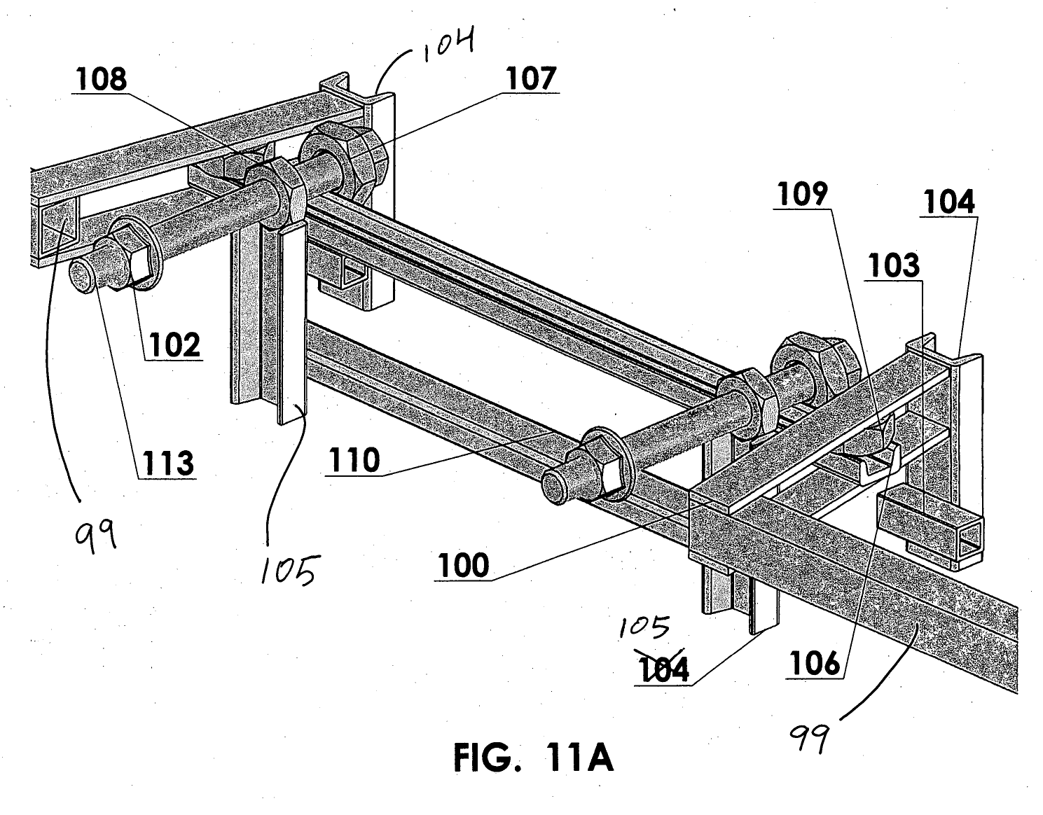

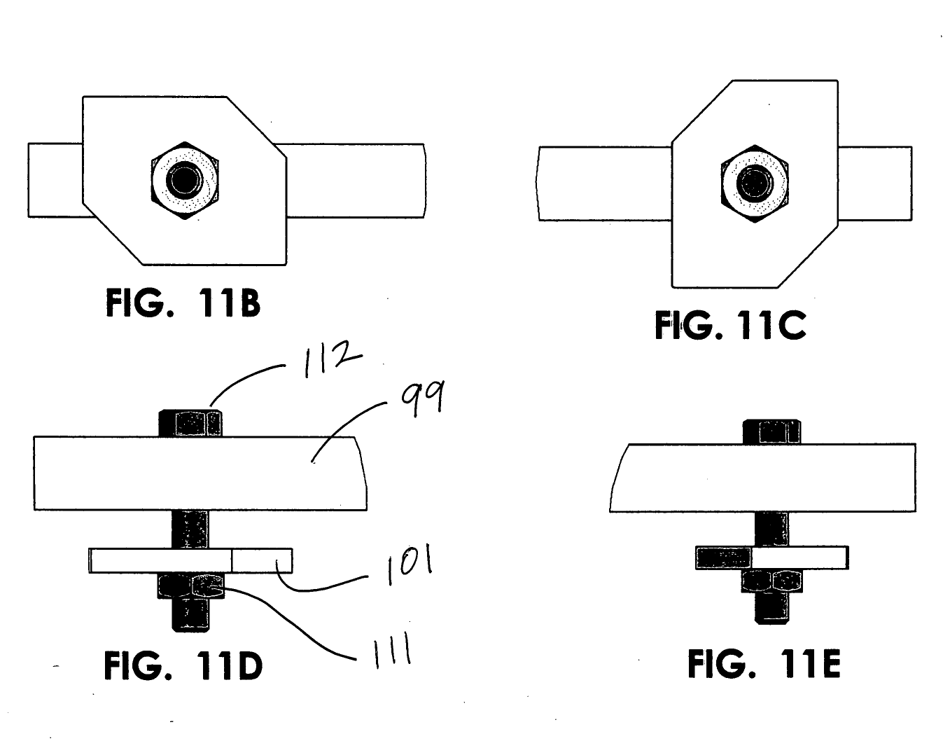

Continuing operation of Winch Assembly 3 will cause mass of Main Frame 4 with Load to become forward biased and pivot downward about the pivot axis created by bolt 30 and bolt anchor 31. Main Frame 4 with Load will then move downward and contact truck bed 9. Roller Frame 2 is held generally parallel to Main Frame 4 due to contact between bottom surface of Main Frame 4 and top edge of hex nuts 46 as hex nuts 46 are attached forward of pivot axis of bearings 43 and 43L. Once Main Frame 4 with Load is in contact with and parallel to truck bed 9 the winching effort is much reduced. Pulling action up the incline ceases and Main Frame 4 with load move smoothly along horizontal and corrugated surface of truck bed 9. Continued winching will cause Main Frame 4 with Load to engage two guide Bolts 113 part of Cross Bar Clamp 5. Bolts 113 align into tubes 77. Threaded end of Bolts 113 receive Nuts 102 to complete the Loading Process. See FIGS. 4, 11 and 11A for added detail. Four distinct positions in the loading sequence are shown in FIGS. 3C through 3F.

Cross Bar Clamp 5 is a weldment with included features to attach to Truck Box 6 at four central contact points and two perimeter contact points and lock Main Frame 4 with Load in a substantially fixed position on truck bed 9. Cross Bar Clamp 5 includes a non-movable portion (the bar), and a movable portion (the clamp). Each half of Cross Bar Clamp 5 is configured thusly: flat bars 100 are welded to long tube 99 forming a shallow angle between them. Front ends of bars 100 are butt welded to channel 104. Tube 103 is welded to channel 104 and functions to engage the rear top edge of truck box cap 8, See FIGS. 11 and 11A. Lower bar 100 is welded to flat side of channel 106 and hex nut 109 is welded to top of channel 106 to connect the two bars 100 on each side. Hex nut 107 is welded at each side to channel 106. Hole in hex nut 107 is sized such that no thread engagement will occur to bolt 113. Hex nut 107 will thusly provide a very low cost and therefore preferred method to locate and constrain bolt 113 during clamping process. Hole is drilled near outer end of each tube 99 to accept hex bolt 112.

The clamp mechanism of Cross Bar Clamp 5 consists of channel 110 welded near bottom of and at right angle to each vertical channel 105. Hex nut 108 is welded to top of each channel 105. A clamp is thusly defined which pulls against rear edge of truck box cap 8 as hex bolts 113 are tightened into hex nuts 108. Plates 101 engage truck box pocket 7 on each side of truck box 6. Prevailing torque type hex nut 111 is welded to each plate 101. As Bolt 112 is rotated into hex nut 111 plate 101 will rotate freely only 90 degrees at which point widest surface of Plate 101 contacts narrow opening dimension of truck box pocket 7 preventing further rotation. Plate 101 also engages beneath metal upper edge of truck box pocket 7. Continuing to tighten Bolt 112 locks both ends of Bed Brace 5 tight into truck box pockets 7 and truck box 6. Fastened thusly Bed Brace 5 provides front-to-rear, side-to-side, and top-to-bottom constraint and insures Main Frame 4 with Load remain tightly clamped and stable during transport. For unusually long Motorcycles such as custom or chopper designs an additional tower clamp 114 is installed after loading as shown in FIG. 3.

Main Frame 4 is constructed primarily of welded steel tubing to provide high strength at lowest weight. Tire and Wheel assemblies 97 and 98 support mass of Load during lift just as they do when Load is at rest. Since Front Tire and Wheel 97 and Rear Tire and Wheel 98 are held in position in Main Frame 4, Motorcycle suspension components do not have to be drawn down or compressed as is required with Tie-down strap systems frequently used in Motorcycle transport. The Motorcycle's internal suspension components may remain active during transport allowing sprung mass of Motorcycle to float up and down as road bumps are encountered.

Design of said lift system allows insertion of Standard 2 inch square trailer ball hitch inside truck receiver hitch 10. Trailer ball hitch is held in place by bolt 29 and nut 28. With Main Frame 4 and Load secured on Truck Bed 9 the substantial distance between truck receiver hitch 10 and bottom of Main Frame 4 allows unhindered access to receiver hitch 10. This design feature enables a camper, boat, or many types of trailers to be coupled to truck and transported at the same time Main Frame 4 with Load is transported.

Lift System as defined above incorporates basic principals of the inclined Plane then adds numerous enhancements. Main Frame 4 with Load is not lifted vertically or positioned to be hanging free as seen in pedestal type lifts in the market. This Lift System causes Main Frame 4 with Load to remain in constant contact with guiding and rolling mechanisms. Rolling interface is provided initially by bearings 43RL and 43RR and finally by contact with four bearings 43,43L, 43RL and 43RR. Guide function is caused initially through proximity position of plates 40 of Roller Frame 2 and subsequently by proximity position of channels 27 and plates 22 of Hitch Frame 1. Using these and other efficiently designed and fabricated components and connection methods provides a product with a level of alignment and stability previously not seen in the art. Another advantage of said Lift System is the reduced operator supplied cranking force required to rotate winch handle 61 when compared to any vertical lift mechanism moving the same mass from ground level to truck bed level.

The invention may further be described as a Lift System to Load, Transport, and Unload Objects weighing up to 1200 pounds from a starting position at or near ground level up to the elevation of a Truck bed comprising a substantially rigid frame that connects to Load holding Load generally vertical and isolating Load from pulling and lifting stresses during loading and transport, and a ramp mechanism which connects to vehicle using standardized vehicle mounted receiver type hitch attaches at such position as to not overstress any vehicle component during loading provides a pivotal axis for the rigid frame with Load allows usage of trailer hitch and ball for pulling other trailer, aligns and supports said rigid frame with Load as rigid frame with Load is pulled along the defined loading path on low friction ball type bearings from starting to final position by operation of Manual Winch device and a clamping system adequate to constrain rigid frame and Load in the forward position on truck bed during transport, whereby as few as one operators will conduct complete and efficient Loading, Clamping, and Unloading functions without need for or use of additional or external clamping or tie-down mechanisms.

The invention may further be described as a Lift System wherein the manually operated Cable Winch is replaced by an Electric powered Cable Winch.

The invention may further be described as a Lift System wherein the manually operated Cable Winch is replaced by an hydraulically powered cable Winch.

The invention may further be described as a Lift System wherein no Winch of any sort would be used resulting in a lower cost Lift System but requiring additional Operators to slide Main Frame 4 with Load up into truck and back down off truck.

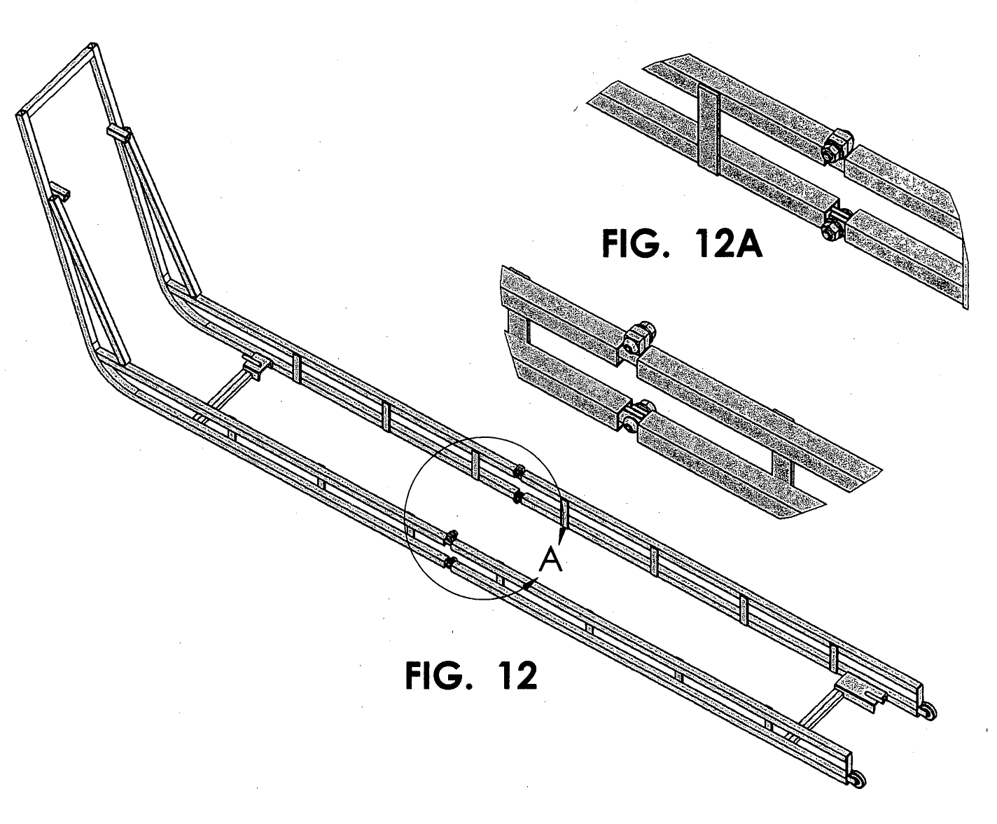

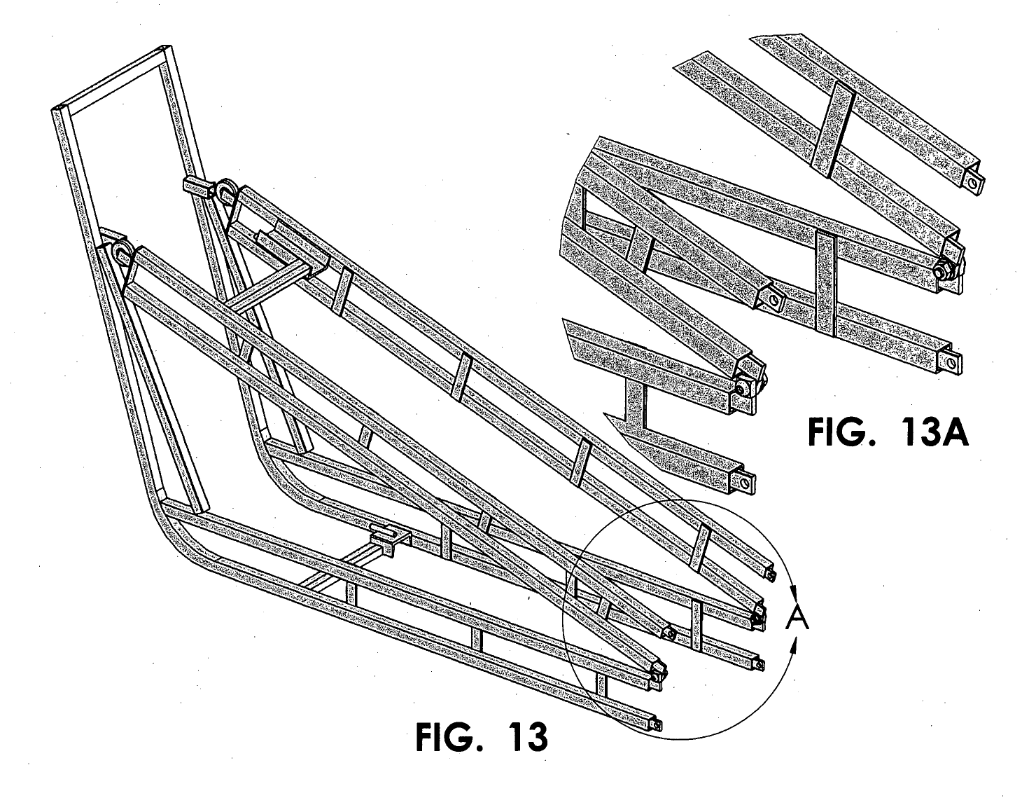

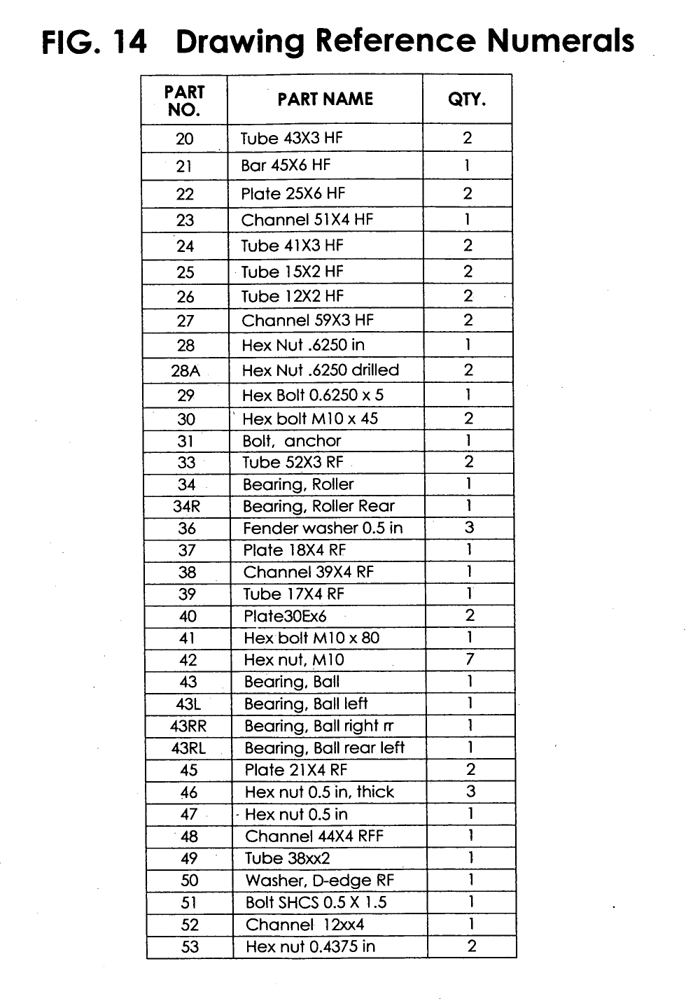

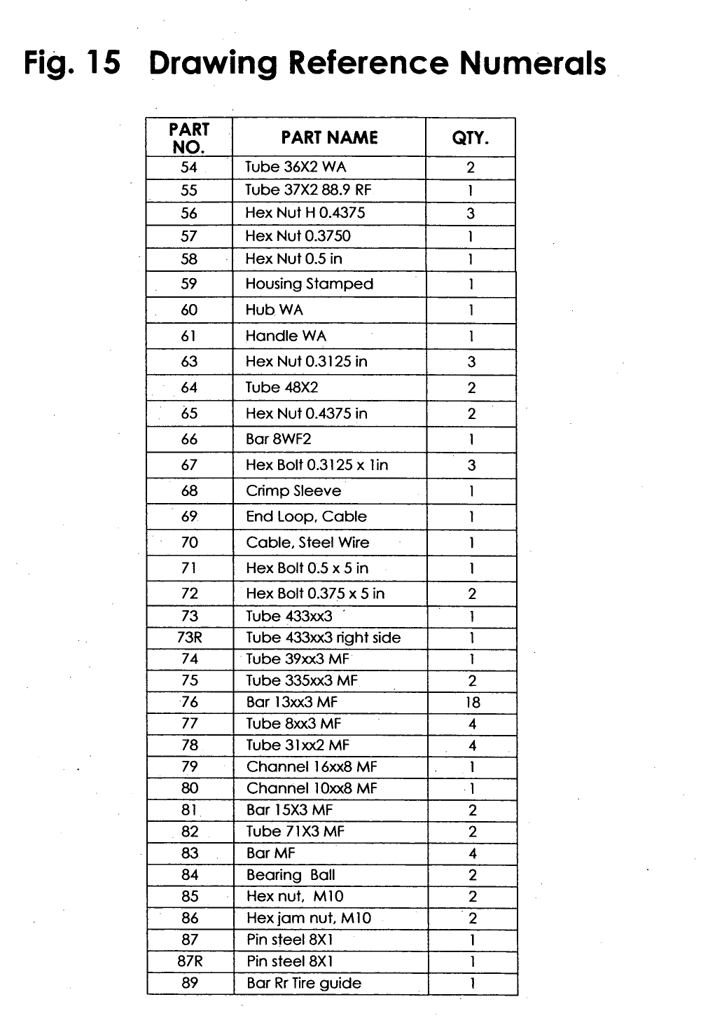

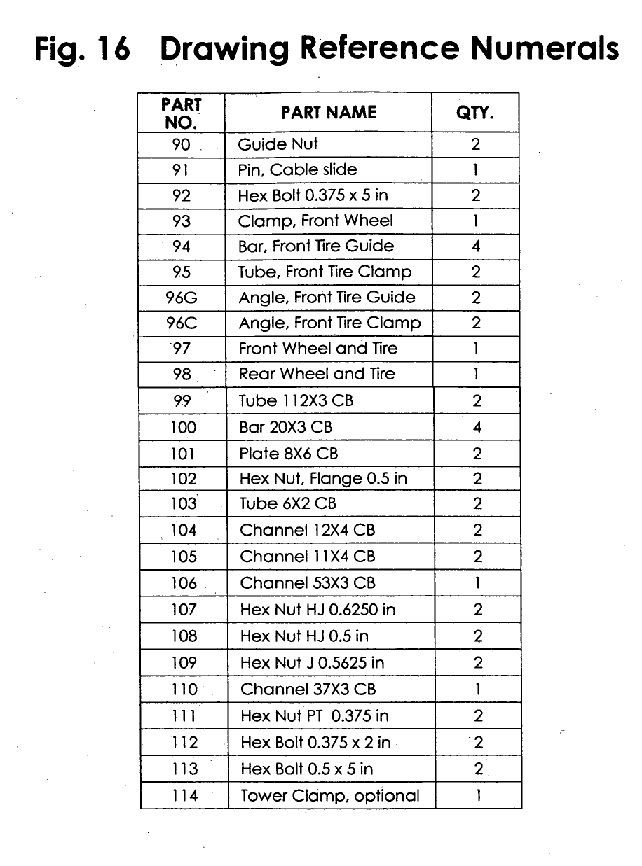

The invention may further be described as a Lift System wherein Main Frame 4 includes a hinge mechanism near center of Frame with detachable fasteners at bottom connection points and permanent fasteners at top hinge points as shown in FIGS. 12, 12A, 13, and 13A. Thusly configured Frame can be folded to approximately one-half its original length to simplify storage when not in use.

The invention may further be described as a Lift System wherein Main Frame 4 includes an extension feature allowing Main Frame 4 to extend to full length for use and compress for storage inside truck or elsewhere when not in use.

The invention may further be described as a Lift System wherein the wall thickness of tubular components is increased in conjunction with adding gussets to stiffen welded joints to handle loads above 1200 pounds.

The invention may further be described as a Lift System wherein the lifted and transported object is rolled into Main Frame 4 and loaded onto the truck “rear wheel first,” in order to position Front Wheel and Tire near rear edge of Truck bed.

The invention may further be described as a Lift System wherein an additional Tire and Wheel clamp such as the clamp illustrated in FIG. 3 is added to improve stability during transport of extra-long objects such as Custom or Chopper type Motorcycles.

The invention may further be described as a Lift System wherein an additional Tire and Wheel clamp such as the Tower Clamp 114 illustrated in FIG. 3 is added to improve stability during transport of standard or custom length Motorcycle or other Load placed on short box truck where part of Load protrudes beyond edge of truck bed.

The invention may further be described as a Lift System wherein the extra-s long object would be lifted and transported “rear wheel first,” in order to position Front Wheel and Tire out beyond rear edge of truck bed.

The invention may further be described as a Lift System wherein ramp mechanism connects to vehicle by method other than standardized vehicle mounted trailer hitch. Examples would include nuts and bolts, welding, etc.

The invention may further be described as a Lift System wherein rigid frame with Load moves along the defined loading path on low friction surfaces other than ball bearings.

The invention may further be described as a Lift System wherein major components or assemblies are stamped from steel using process such as progressive die suitable for higher volume of production.

The invention may further be described as a Lift System wherein ramp mechanism is lengthened substantially so that Main Frame 4 and Load could be manually pushed up ramp and on to truck bed.

The invention may further be described as a Lift System wherein Main Frame 4 would include a caster wheel at each corner to allow rolling Main Frame 4 with Load easily in any direction for storage inside garage or other building.

### OPERATION OF INVENTION—FIGS. 1 THRU 5—PREFERRED EMBODIMENT

A preferred embodiment of this lift and transport system includes all hardware required to lift a two-wheeled Motorcycle or similar Load from ground level to the bed of a Truck and securely fasten said Motorcycle to Truck Bed 9 for transport. Motorcycle loading process or the lifting from ground level to truck bed, will be described in detail below. Motorcycle unloading or lowering process will be described only where it differs from loading process.

Main Frame 4 is set to a position where front edges of tubes 73 and 73R contact bearings 43RL and 43RR respectively. Cable end loop 69 part of Winch Assembly 3 is attached to pin 87R. Winch handle 61 is rotated to take up cable slack and pull Main Frame 4 tight against two bearings 43RL and 43RR. Motorcycle is rolled or driven onto Main Frame 4. Front wheel and tire 97 rolls against bars 94 and is held firm. Front wheel and tire 97 is clamped securely by installing Front wheel clamp 93 and tightening bolts 92.

Operation of Winch Assembly 3 lifts front end of Main Frame 4 with Load. Continued operation of Winch Assembly 3 rolls Main Frame 4 with Load along bearings 43RL and 43RR, bearings 43 and 43L and finally up to surface of Truck Bed 9. Lastly Main Frame 4 engages bolts 113 of Cross Bar Clamp 5. Hex nuts 102 are installed and tightened, completing the loading process. Winch Handle 61 is rotated one or two more clicks of ratchet mechanism to pull Cable taut during transport.

Motorcycle is now clamped and secure and will not move appreciably in any direction during transport. No additional strapping or tie-down of motorcycle is needed. After motorcycle has been transported to destination, hex nuts 102 are removed from bolts 113 allowing Main Frame 4 to be moved rearward. Winch Handle 61 is rotated slightly and Winch Assembly 3 is set to Free-Wheel position so Cable end loop 69 is free to be removed from rear Pin 87R on Main Frame 4. Cable 70 is routed for unloading per FIGS. 3A and 3B. Cable 70 is set beneath washer 50 and around rear side of bearing 34 then forward up through Channel 80. Cable end loop 69 is now set over front pin 87. Winch Assembly 3 is set to Ratchet-Lock position. Operation of Winch Assembly 3 will now pull Main Frame 4 with Load backwards toward rear of truck bed 9. Above described position is shown in FIG. 3A. Cable routing path for above described position is shown in FIG. 3B.

As Main Frame 4 with Load approach the balanced front-to-rear or free-to-pivot position, rotation of Winch Handle 61 is halted. Winch Assembly 3 is set to free-wheel position to remove cable 70 from pin 87. Cable End Loop 69 is placed back per initial routing and re-attached over rear Pin 87R on top of Channel 79. Winch Assembly 3 is set to Ratchet-Lock position and rotated as needed to remove slack from cable. Operator grasps rear of Main Frame 4 with Load and applies a slight downward force causing Main Frame 4 with Load and Roller Frame 2 to pivot downward at axis of bearings 43 and 43L until contacting surface of Hitch Frame 1. As Cable slack tightens Main Frame 4 with Load will roll slightly downward and be held fast by tight cable. The unique and functional design of this system allows Winch Assembly 3 to pivot on same axis as Roller Frame 2 and Main Frame 4. This feature keeps cable 70 taut during operation and prevents jerking or pinching of cable 70 as Main Frame 4 with Load changes attitudes during the loading process. Winch Handle 49 is rotated slightly and held tight as Winch Assembly 3 is set to Free-Wheel position. Main Frame 4 with Load is lowered by controlled operation of Winch Handle 49. Bearings 84 contact ground first causing Main Frame 4 with Load to continue rolling rearward until all of bottom surface of Main Frame 4 rests on ground. Motorcycle is detached from Main Frame 4 and is ready for use.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A device for use in lifting a load into a box of a truck having a trailer hitch and transporting the load, comprising:
a substantially rigid main frame, wherein the main frame defines a loading path for the load and connects to the load;
a hitch frame, wherein the hitch frame is connected to the trailer hitch and supported by the bed of the truck; and
a roller frame having a plurality of low friction surfaces, wherein the roller frame fits on the hitch frame, wherein the main frame contacts the plurality of low friction surfaces when lifting the load into the box.

2. The device of claim 1, wherein the main frame further comprises means for clamping the load to the main frame.

3. The device of claim 2, wherein the main frame further comprises a front end having an upwardly extending portion, wherein the means for clamping the load to the main frame is on the upwardly extending portion.

4. The device of claim 1, wherein the main frame further comprises a rear end, wherein a second means for clamping the load to the main frame is toward the rear end.

5. The device of claim 3, wherein the means for clamping the load to the main frame clamps on a wheel of a motorcycle.

6. The device of claim 1, further comprising means for clamping the main frame to the box.

7. The device of claim 1, further comprising a cross bar clamp, wherein the cross bar clamp attaches to the box, further wherein the main frame engages the cross bar clamp.

8. The device of claim 1, further comprising means for attaching the cross bar clamp to the side of the box.

9. The device of claim 1, further comprising means for attaching the cross bar clamp to the truck box cap.

10. The device of claim 1, the hitch frame having a channel for contacting the trailer hitch and supporting at least a portion of the load.

11. The device of claim 1, wherein the roller frame further comprises a winch assembly having a cable, further wherein the main frame and roller frame have means for routing the cable from the winch assembly to the main frame, further wherein the main frame has means for attaching the cable to the main frame.

12. The device of claim 1, wherein the device is useful for lifting and transporting the load to a central position in the truck box.

13. The device of claim 1, wherein operation of the winch assembly is selected from the group consisting of manual operation, electrical operation and hydraulic operation.

14. The device of claim 1, wherein the main frame further comprises means for folding the main frame, wherein the overall length of the main frame is reduced after being folded, when the main frame is not in use.

15. The device of claim 1, wherein the main frame, hitch frame and roller frame form a ramp mechanism for moving the load into the box.

16. The device of claim 1, wherein the main frame further comprises a rear end, wherein the main frame has wheels at the rear end.

17. A clamp, comprising:
a tube having holes;
a bolt passing through the holes;
a cross bar clamp plate having a hexagonal shape, wherein the lengths of the sides of the cross bar clamp plate are different, further wherein the distances between parallel sides of the cross bar clamp plate vary; and
a nut welded to the cross bar clamp plate for engaging the bolt.

18. A method for lifting a load into a box of a truck having a trailer hitch, comprising:
securing the load to a main frame;
guiding and lifting the load up to the bed of the truck by moving the load along a loading path having low friction surfaces;
sliding the load to the full-forward position in the box; and
fastening the load to the box;
wherein stable transport on a highway is achieved.

19. The device of claim 1, wherein the load is selected from the group consisting of motorcycles, snowmobiles, all-terrain vehicles, lawn mowers, tillers and appliances.

20. The device of claim 1, wherein the device is readily removable from the truck.
